(19) United States
(12) Patent Application Publication
(10) Pub. No.: US 2023/0171609 A1
(43) Pub. Date: Jun. 1, 2023

(54) STATION PLACEMENT SUPPORT METHOD, STATION PLACEMENT SUPPORT APPARATUS AND STATION PLACEMENT SUPPORT PROGRAM

(71) Applicant: NIPPON TELEGRAPH AND TELEPHONE CORPORATION, Tokyo (JP)

(72) Inventors: Hideyuki TSUBOI, Musashino-shi, Tokyo (JP); Kazuto GOTO, Musashino-shi, Tokyo (JP); Hideki TOSHINAGA, Musashino-shi, Tokyo (JP); Tatsuhiko IWAKUNI, Musashino-shi, Tokyo (JP); Shuki WAI, Musashino-shi, Tokyo (JP); Daisei UCHIDA, Musashino-shi, Tokyo (JP); Yushi SHIRATO, Musashino-shi, Tokyo (JP); Naoki KITA, Musashino-shi, Tokyo (JP); Takeshi ONIZAWA, Musashino-shi, Tokyo (JP)

(73) Assignee: NIPPON TELEGRAPH AND TELEPHONE CORPORATION, Tokyo (JP)

(21) Appl. No.: 17/915,036

(22) PCT Filed: Mar. 31, 2020
(86) PCT No.: PCT/JP2020/014742

§ 371 Date: Sep. 27, 2022

(51) Int. Cl. H04W 16/18

(52) U.S. Cl. CPC H04W 16/18

(57) ABSTRACT

A method includes generating, based on data indicating the travel trajectory of a mobile object, which acquires point group data indicating the position of an object present in a three-dimensional space within a predetermined measurable distance, the measurable distance, candidate base station position data indicating a candidate position for installing a base station apparatus, and candidate terminal station position data indicating a candidate position for installing a terminal station apparatus, data indicating the positional relationship between the travel trajectory and a candidate base station position, and data indicating the positional relationship between the travel trajectory and a candidate terminal station position; generating data indicating a measurable range based on the travel trajectory data and the measurable distance; generating data indicating a connecting line segment connecting the candidate base station position and the candidate terminal station position based on the candidate base station position data and the candidate terminal station position data; and identifying a confidence coefficient indicating the degree of reliability of the processing result of a predetermined evaluation process performed based on the point group data, based on the proportion of the connecting line segment present within the measurable range.

### TECHNICAL FIELD

The present invention relates to a station deployment support method, a station deployment support apparatus, and a station deployment support program.

### BACKGROUND ART

FIG. 24 is a partially modified schematic view of, regarding TIP (Telecom Infra Project) that is a consortium working together to accelerate the openness of the specifications of the general communication network devices (main members: Facebook, Deutsche Telecom, Intel, NOKIA, etc.), a use case proposed by mmWave Networks as a reference (for example, see Non-Patent Literatures 1 to 3). The mmWave Networks is one of the project groups of TIP and is aiming at constructing a network that is inexpensive and faster than deploying an optical fiber, using millimeter-wave radio signals in an unlicensed band.

Referring to buildings, such as buildings 800 and 801 and houses 810, 811, and 812, illustrated in FIG. 24, each of terminal station apparatuses (hereinafter referred to as “terminal stations”) 840 to 844, which are installed on wall surfaces of the respective buildings, and base station apparatuses (hereinafter referred to as “base stations”) 830 to 834, which are installed on utility poles 821 to 826, is an apparatus called mmWave DN (Distribution Node).

Each of the base stations 830 to 834 is connected to one of communication apparatuses provided in telephone exchange stations (Fiber PoP (Point of Presence)) 850 and 851 by an optical fiber 900 or 901. The communication apparatuses are connected to a communication network of a provider. The mmWave Link, that is, millimeter-wave wireless communication is performed between one of the terminal stations 840 to 844 and one of the base stations 830 to 834 (hereinafter also referred to as “between the two stations”). In FIG. 24, millimeter-wave wireless links are indicated by alternate long and short dash lines.

In a configuration in which the base stations 830 to 834 are installed on the utility poles 821 to 826, the terminal stations 840 to 844 are installed on the wall surfaces of the buildings, and millimeter-wave wireless communication is performed between the two stations, the act of selecting candidate positions for installing the base stations 830 to 834 and the terminal stations 840 to 844 is referred to as station deployment design (hereinafter also referred to as “station deployment”).

### CITATION LIST

### Non-Patent Literature

Non-Patent Literature 1: Sean Kinney, “Telecom Infra Project focuses on millimeter wave for dense networks, Millimeter Wave Networks Project Group eyes 60 GHz band”, Image courtesy of the Telecom Infra Project, RCR Wireless News, Intelligence on all things wireless, Sep. 13, 2017, [searched Mar. 6, 2020], the website (URL: https://www.rcrwireless.com/20170913/carriers/telecom-infra-project-millimeter-wave-tag17)

Non-Patent Literature 2: Frederic Lardinois, “Facebook-backed Telecom Infra Project adds a new focus on millimeter wave tech for 5G”, [searched Mar. 6, 2020], the website (URL:

https://techcrunch.com/2017/09/12/facebook-backed-telecom-infra-project-adds-a-new-focus-on-millimeter-wave-tech-for-5g/?renderMode=ie11)

Non-Patent Literature 3: Jamie Davies, “DT and Facebook TIP the scales for mmWave”, GLOTEL AWARDS 2019, telecoms.com, Sep. 12, 2017, [searched Mar. 6, 2020], the website (URL: http://telecoms.com/484622/dt-and-facebook-tip-the-scales-for-mmwave/)

### SUMMARY OF THE INVENTION

### Technical Problem

As a method of station deployment design, there is known a method that uses three-dimensional point group data obtained by capturing an image of a space. Such a method includes, for example, first driving a mobile object, such as a vehicle, having an MMS (Mobile Mapping System) mounted thereon along a road around a residential area as an evaluation target to acquire three-dimensional point group data, and then evaluating wireless communication between one of the base stations 830 to 834 and one of the terminal stations 840 to 844 utilizing the acquired point group data. As an evaluation means, there is known a means of determining three-dimensional visibility or a means of calculating the shield factor for a space between the two stations. The “shield factor” herein is an index indicating the degree of influence of an object, which is present between one of the base stations 830 to 834 and one of the terminal stations 840 to 844, on the wireless communication, and may also be referred to as “transmissivity” from the opposite perspective. To implement such an evaluation means, it is necessary to prepare point group data on all evaluation targets in the space including the candidate positions of the base stations 830 to 834 and the terminal stations 840 to 844.

However, even when a mobile object having an MMS mounted thereon has traveled extensively in advance in an area set as an evaluation target by an apparatus for supporting station deployment design, there are many places from which point group data has been partially difficult to obtain. Alternatively, when the range of the evaluation target contains no point group data at all, it is necessary to collect new point group data. However, when the mobile object has already traveled in the range of the evaluation target, it is often the case that only the point group data that has been already obtained through the travel is used. If station deployment design is performed with the apparatus based on such point group data with partially missing information, a processing result with low accuracy may be output.

For example, assume that even when there is an object in a space between the base station 830 and the terminal station 840, point group data on the object has not been acquired. In such a case, even if an apparatus for supporting station deployment performs three-dimensional visibility determination or shield factor calculation for the space between the two stations utilizing the acquired point group data, the apparatus performs a process on the assumption that there is no shielding object between the two stations because there is no point group data on the space between the two stations. Consequently, the apparatus for supporting station deployment design may erroneously determine that the space is “visible” or erroneously calculate the shield factor as a “low shield factor” that is sufficient to perform wireless communication. Therefore, the reliability of the processing result may decrease, which in turn may prompt a user to perform erroneous determination, for example, install the terminal station 840 on a wall surface of an inappropriate building.

There is also a case where one of the base station 830 and the terminal station 840 is present in the range in which point group data has not been acquired or is not present in the range around the travel trajectory of a mobile object having an MMS mounted thereon. In such a case also, a three-dimensional visibility determination or shield factor calculation process may be influenced depending on the positional relationship among the base station 830, the terminal station 840, and the travel trajectory. Therefore, the reliability of the processing result may decrease, which in turn may prompt a user to perform erroneous determination.

In view of the foregoing circumstances, it is an object of the present invention to provide a technique that allows a user to perform appropriate station deployment design even when the state of acquisition of point group data from a space between a candidate position for installing a base station and a candidate position for installing a terminal station is not good.

### Means for Solving the Problem

An aspect of the present invention is a station deployment support method including a positional relationship identification step of, based on travel trajectory data indicating a travel trajectory of a mobile object that measures an object present in a three-dimensional space within a predetermined measurable distance and acquires point group data indicating a position of the measured object in the three-dimensional space, the measurable distance, candidate base station position data indicating a candidate position for installing a base station apparatus, and candidate terminal station position data indicating a candidate position for installing a terminal station apparatus, generating base station positional relationship identification data indicating a positional relationship between the travel trajectory and a candidate base station position, and terminal station positional relationship identification data indicating a positional relationship between the travel trajectory and a candidate terminal station position; a measurable range identification step of generating measurable range data indicating a measurable range based on the travel trajectory data and the measurable distance; a connecting line segment identification step of, based on the candidate base station position data and the candidate terminal station position data, generating connecting line segment data indicating a connecting line segment connecting the candidate base station position and the candidate terminal station position; and a confidence coefficient identification step of, based on a proportion of the connecting line segment present within the measurable range, identifying a confidence coefficient indicating a degree of reliability of a processing result of a predetermined evaluation process performed based on the point group data.

In addition, an aspect of the present invention is a station deployment support apparatus including a positional relationship identification unit that, based on travel trajectory data indicating a travel trajectory of a mobile object that measures an object present in a three-dimensional space within a predetermined measurable distance and acquires point group data indicating a position of the measured object in the three-dimensional space, the measurable distance, candidate base station position data indicating a candidate position for installing a base station apparatus, and candidate terminal station position data indicating a candidate position for installing a terminal station apparatus, generates base station positional relationship identification data indicating a positional relationship between the travel trajectory and a candidate base station position, and terminal station positional relationship identification data indicating a positional relationship between the travel trajectory and a candidate terminal station position; a measurable range identification unit that generates measurable range data indicating a measurable range based on the travel trajectory data and the measurable distance; a connecting line segment identification unit that, based on the candidate base station position data and the candidate terminal station position data, generates connecting line segment data indicating a connecting line segment connecting the candidate base station position and the candidate terminal station position; and a confidence coefficient identification unit that, based on a proportion of the connecting line segment present within the measurable range, identifies a confidence coefficient indicating a degree of reliability of a processing result of a predetermined evaluation process performed based on the point group data.

In addition, an aspect of the present invention is a station deployment support program for causing a computer to execute a positional relationship identification step of, based on travel trajectory data indicating a travel trajectory of a mobile object that measures an object present in a three-dimensional space within a predetermined measurable distance and acquires point group data indicating a position of the measured object in the three-dimensional space, the measurable distance, candidate base station position data indicating a candidate position for installing a base station apparatus, and candidate terminal station position data indicating a candidate position for installing a terminal station apparatus, generating base station positional relationship identification data indicating a positional relationship between the travel trajectory and a candidate base station position, and terminal station positional relationship identification data indicating a positional relationship between the travel trajectory and a candidate terminal station position; a measurable range identification step of generating measurable range data indicating a measurable range based on the travel trajectory data and the measurable distance; a connecting line segment identification step of, based on the candidate base station position data and the candidate terminal station position data, generating connecting line segment data indicating a connecting line segment connecting the candidate base station position and the candidate terminal station position; and a confidence coefficient identification step of, based on a proportion of the connecting line segment present within the measurable range, identifying a confidence coefficient indicating a degree of reliability of a processing result of a predetermined evaluation process performed based on the point group data.

### Effect of the Invention

The present invention allows a user to perform appropriate station deployment design even when the state of acquisition of point group data from a space between a candidate position for installing a base station and a candidate position for installing a terminal station is not good.

### BRIEF DESCRIPTION OF DRAWINGS

FIG. 1 is a block diagram illustrating the configuration of a station deployment support apparatus of a first embodiment.

FIG. 2 is a flowchart illustrating a process flow of the station deployment support apparatus of the first embodiment.

FIG. 3 is a view for describing a process of the station deployment support apparatus of the first embodiment in two stages.

FIG. 4 is a block diagram illustrating the configuration of a point group data processing unit in a station deployment support apparatus of a second embodiment.

FIG. 5 is a view illustrating the configuration of the positional relationship among a travel trajectory, a candidate base station position, and a candidate terminal station position in the second embodiment.

FIG. 6 is a view illustrating the configuration of the positional relationship among a travel trajectory, a candidate base station position, and a candidate terminal station position in the second embodiment.

FIG. 7 is a view illustrating the configuration of the positional relationship among a travel trajectory, a candidate base station position, and a candidate terminal station position in the second embodiment.

FIG. 8 is a view illustrating the configuration of the positional relationship among a travel trajectory, a candidate base station position, and a candidate terminal station position in the second embodiment.

FIG. 9 is a view illustrating the configuration of the positional relationship among a travel trajectory, a candidate base station position, and a candidate terminal station position in the second embodiment.

FIG. 10 is a view illustrating the configuration of the positional relationship among a travel trajectory, a candidate base station position, and a candidate terminal station position in the second embodiment.

FIG. 11 is a view illustrating the configuration of the positional relationship among a travel trajectory, a candidate base station position, and a candidate terminal station position in the second embodiment.

FIG. 12 is a view illustrating the configuration of the positional relationship among a travel trajectory, a candidate base station position, and a candidate terminal station position in the second embodiment.

FIG. 13 is a view illustrating the configuration of the positional relationship among a travel trajectory, a candidate base station position, and a candidate terminal station position in the second embodiment.

FIG. 14 is a view illustrating the configuration of the positional relationship among a travel trajectory, a candidate base station position, and a candidate terminal station position in the second embodiment.

FIG. 15 is a flowchart illustrating a process flow of a point group data processing unit in the station deployment support apparatus of the second embodiment.

FIG. 16 is a view illustrating a plurality of travel sections and a plurality of travel trajectories of a mobile object in a third embodiment.

FIG. 17 is an enlarged view of a part of a range around a travel trajectory 50b in the third embodiment.

FIG. 18 is an enlarged view of a part of the range around the travel trajectory 50b and a range around a travel trajectory 50c in the third embodiment.

FIG. 19 is an enlarged view of a part of the range around the travel trajectory 50b and the range around the travel trajectory 50c in the third embodiment.

FIG. 20 is a view illustrating the configuration of the positional relationship among travel trajectories, a candidate base station position, and a candidate terminal station position in the third embodiment.

FIG. 21 is a flowchart illustrating a station deployment support method according to the third embodiment.

FIG. 22 is a flowchart illustrating a process flow of a point group data processing unit in a station deployment support apparatus of the third embodiment.

FIG. 23 is a view illustrating an example in which a plurality of candidate terminal station positions are present in a fourth embodiment.

FIG. 24 is a view illustrating an example of a use case proposed by TIP.

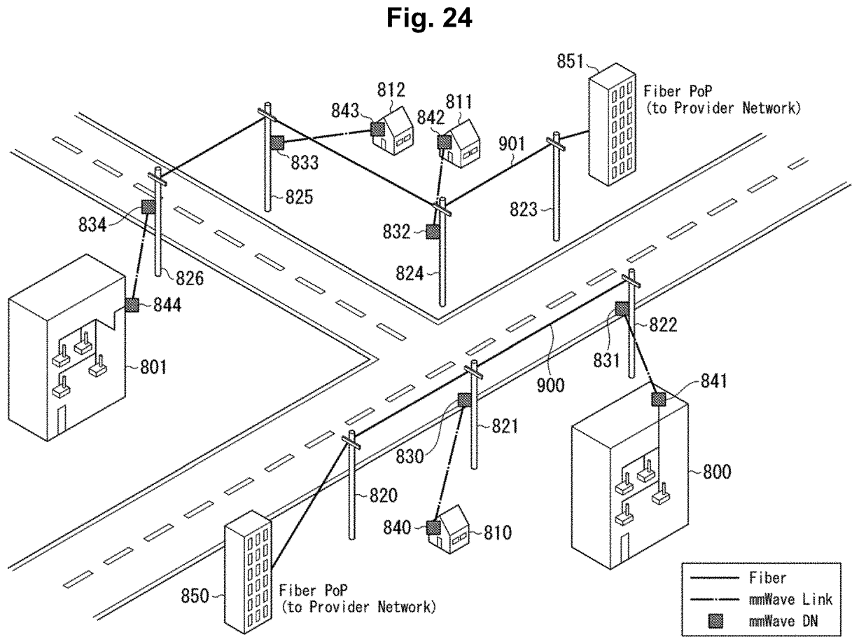

### DESCRIPTION OF EMBODIMENTS

### First Embodiment

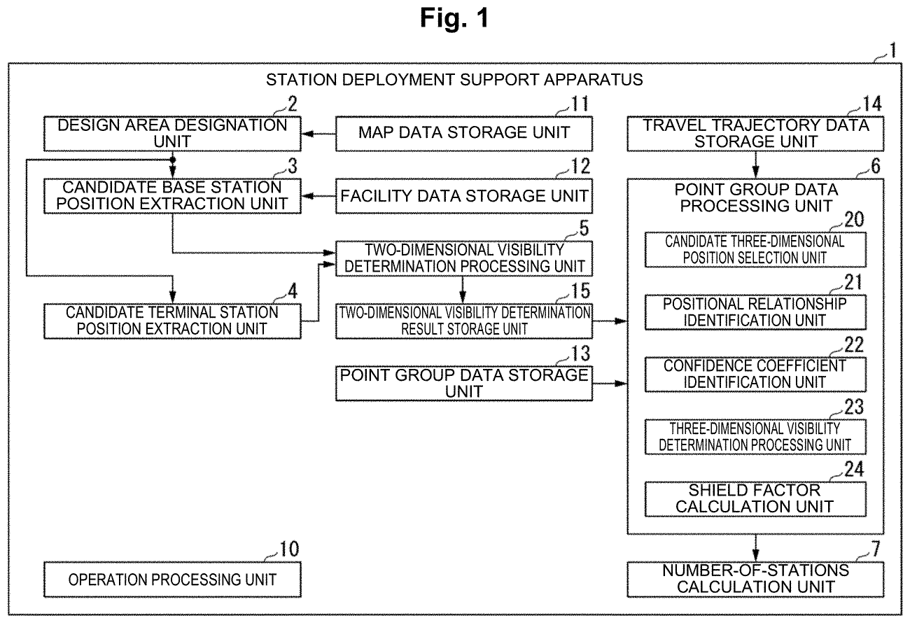

Hereinafter, a first embodiment of the present invention will be described with reference to the drawings. FIG. 1 is a block diagram illustrating the configuration of a station deployment support apparatus 1 that is an apparatus for supporting station deployment design of the first embodiment. The station deployment support apparatus 1 includes a design area designation unit 2, a candidate base station position extraction unit 3, a candidate terminal station position extraction unit 4, a two-dimensional visibility determination processing unit 5, a point group data processing unit 6, a number-of-stations calculation unit 7, an operation processing unit 10, a map data storage unit 11, a facility data storage unit 12, a point group data storage unit 13, a travel trajectory data storage unit 14, and a two-dimensional visibility determination result storage unit 15. The point group data processing unit 6 includes a candidate three-dimensional position selection unit 20, a positional relationship identification unit 21, a confidence coefficient identification unit 22, a three-dimensional visibility determination processing unit 23, and a shield factor calculation unit 24.

Described below is data stored in advance in the map data storage unit 11, the facility data storage unit 12, the point group data storage unit 13, and the travel trajectory data storage unit 14 of the station deployment support apparatus 1.

The map data storage unit 11 stores two-dimensional map data in advance. The map data includes, for example, data indicating the position and the shape of a candidate building in which a terminal station is to be installed, data indicating the range of the site of the building, and data indicating a road. The facility data storage unit 12 stores candidate base station position data on the two-dimensional coordinate system (hereinafter referred to as “candidate two-dimensional base station position data”) indicating a candidate base station installation building structure that is an outdoor facility, such as a utility pole, on which a base station is to be installed.

The point group data storage unit 13 stores three-dimensional point group data acquired by an MMS, for example. The travel trajectory data storage unit 14 stores in advance travel trajectory data indicating the travel trajectory of a mobile object, such as a vehicle, having an MMS mounted thereon, for example. Herein, the travel trajectory data is data represented by a two-dimensional line segment on the coordinate system of the map data, for example.

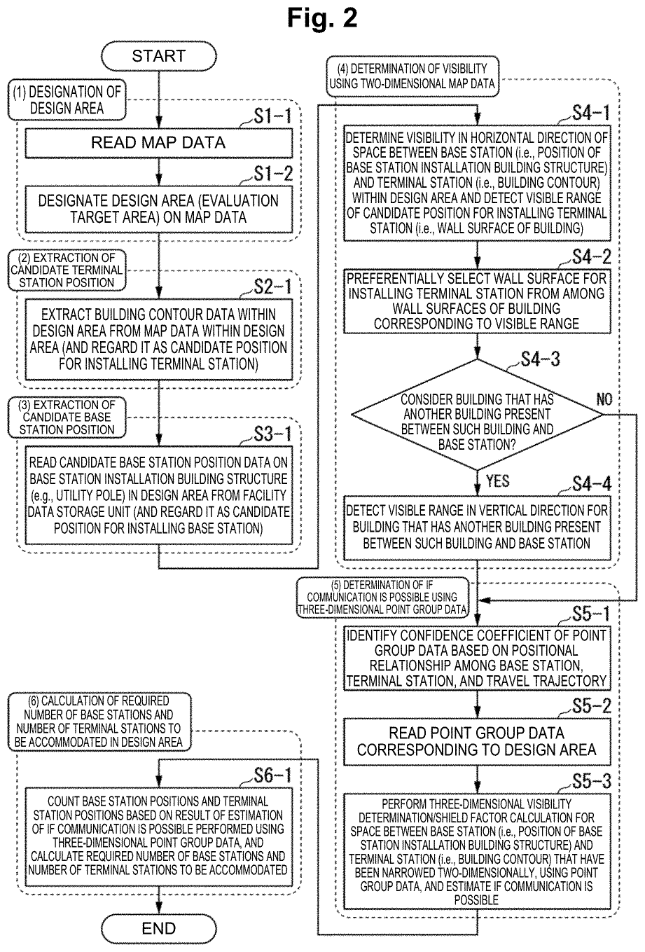

Hereinafter, the configuration of each functional unit of the station deployment support apparatus 1 as well as a process flow of a station deployment support method performed by the station deployment support apparatus 1 will be described with reference to a flowchart illustrated in FIG. 2.

The design area designation unit 2 reads the two-dimensional map data from the map data storage unit 11 (step S1-1). The design area designation unit 2 writes and stores the read map data into a working memory, for example. The design area designation unit 2 selects a rectangular area on the map data stored in the working memory based on a designation signal designating the range of a design area output from the operation processing unit 10 in response to an operation of the user of the station deployment support apparatus 1, for example. The design area designation unit 2 designates the selected area as a design area (step S1-2).

The candidate terminal station position extraction unit 4 extracts, for each building, building contour data, which indicates the position and the shape of the building, from the map data within the design area (step S2-1). The building contour data extracted by the candidate terminal station position extraction unit 4 is data indicating a wall surface of the building on which a terminal station may possibly be installed, and thus is regarded as a candidate position for installing a terminal station.

The candidate terminal station position extraction unit 4 generates building identification data, which is identification information capable of uniquely identifying each individual building, and provides the data to the extracted building contour data on each building. The candidate terminal station position extraction unit 4 associates the thus provided building identification data with the building contour data corresponding to the building, and outputs the resulting data.

The candidate base station position extraction unit 3 reads from the facility data storage unit 12 candidate two-dimensional base station position data corresponding to a base station installation building structure located in the design area designated by the design area designation unit 2, and outputs the read data (step S3-1). It should be noted that when the coordinates of the map data stored in the map data storage unit 11 do not coincide with the coordinates of the candidate two-dimensional base station position data stored in the facility data storage unit 12, the candidate base station position extraction unit 3 converts the coordinates of the read candidate two-dimensional base station position data into the coordinate system of the map data.

The two-dimensional visibility determination processing unit 5 performs, for each piece of the candidate two-dimensional base station position data output from the candidate base station position extraction unit 3, determination of whether each building is visible in the horizontal direction from the position indicated by each piece of the candidate two-dimensional base station position data, based on the building contour data on each building output from the candidate terminal station position extraction unit 4, using a means disclosed in Reference 1 (Japanese Patent Application No. 2019-004727), for example. The two-dimensional visibility determination processing unit 5 detects as the visible range the range of the building that has been determined to be visible, that is, wall surfaces of the building (step S4-1).

The two-dimensional visibility determination processing unit 5 further preferentially selects, from among the wall surfaces of the building corresponding to the detected visible range, a candidate wall surface of the building for installing a terminal station. When the visible range of a given building includes a plurality of wall surfaces, for example, the two-dimensional visibility determination processing unit 5 preferentially determines a wall surface closer to the base station as a wall surface for installing a terminal station, and selects such a wall surface as a final visible range in the horizontal direction.

It should be noted that when the visible range of a given building includes a plurality of wall surfaces, the method of selecting a wall surface is not limited to the aforementioned method and may be any method. For example, selection may be performed based on the value of a confidence coefficient described below.

The two-dimensional visibility determination processing unit 5 associates, for each candidate base station position, the building contour data on the building having the detected visible range in the horizontal direction with data indicating the visible range in the horizontal direction of the building, and writes and stores the resulting data into the two-dimensional visibility determination result storage unit 15 (step S4-2). Accordingly, building identification data on a building as well as data indicating the visible range in the horizontal direction of the building corresponding to the building identification data is stored in the two-dimensional visibility determination result storage unit 15 for each piece of candidate two-dimensional base station position data.

The two-dimensional visibility determination processing unit 5 determines the presence or absence of an instruction signal, which indicates “an instruction to consider a building that has another building present between such building and the candidate base station position,” output from the operation processing unit 10 in response to an operation of the user of the station deployment support apparatus 1 (step S4-3). It should be noted that the user of the station deployment support apparatus 1 has selected in advance whether to consider a building that has another building present between such building and the candidate base station position before the process in FIG. 2 is started, and if the user has selected to consider such building, the operation processing unit 10 outputs an instruction signal indicating “an instruction to consider a building that has another building present between such building and the candidate base station position” in response to an operation of the user.

If the two-dimensional visibility determination processing unit 5 determines that such an instruction signal is not received (step S4-3, No), the process proceeds to step S5-1. Meanwhile, if the two-dimensional visibility determination processing unit 5 determines that such an instruction signal is received (step S4-3, Yes), the process proceeds to step S4-4.

The two-dimensional visibility determination processing unit 5 detects, for each piece of candidate two-dimensional base station position data, a building that has another building present between such building and the position indicated by the candidate two-dimensional base station position data, as a target building for which visibility in the vertical direction is to be detected, among buildings within the design area. For example, the two-dimensional visibility determination processing unit 5 refers to the two-dimensional visibility determination result storage unit 15, and, for each piece of candidate two-dimensional base station position data, determines a building without the visible range detected in the horizontal direction as a building that has another building present such building and the position indicated by the candidate two-dimensional base station position data, and thus detects the building as a target building for which visibility in the vertical direction is to be detected (hereinafter, a target building for which visibility in the vertical direction is to be detected shall also be referred to as a “visibility-detection-target building”).

The two-dimensional visibility determination processing unit 5, in response to an operation of the user of the station deployment support apparatus 1, captures from the outside data indicating the installation altitude for each candidate base station position designated by the user as well as data indicating the height of each building, for example.

The two-dimensional visibility determination processing unit 5 performs, for each visibility-detection-target building for each detected candidate base station position, detection of the visible range in the vertical direction from the height of the installation altitude at the candidate base station position, using the captured data indicating the height of the building. The two-dimensional visibility determination processing unit 5 associates the building identification data on the building having the detected visible range in the vertical direction with data indicating the detected visible range in the vertical direction of the building, and writes and stores the resulting data into the two-dimensional visibility determination result storage unit 15 (step S4-4). Accordingly, building identification data on a building as well as data indicating the visible range in the horizontal and vertical directions of the building corresponding to the building identification data is stored in the two-dimensional visibility determination result storage unit 15 for each piece of candidate two-dimensional base station position data.

The candidate three-dimensional position selection unit 20 in the point group data processing unit 6 selects a candidate base station position indicating a candidate position for installing a base station in a three-dimensional space, and a candidate terminal station position indicating a candidate position for installing a terminal station in the three-dimensional space.

For example, the user of the station deployment support apparatus 1 operates the operation processing unit 10 to select one piece of candidate two-dimensional base station position data from the two-dimensional visibility determination result storage unit 15. The operation processing unit 10 outputs the selected candidate two-dimensional base station position data to the candidate three-dimensional position selection unit 20. The candidate three-dimensional position selection unit 20 captures the candidate two-dimensional base station position data output from the operation processing unit 10. The candidate three-dimensional position selection unit 20 acquires from the point group data storage unit 13 point group data around the position indicated by the captured candidate two-dimensional base station position data, and displays the acquired point group data on a screen. The user operates the operation processing unit 10 to select a candidate three-dimensional position for installing a base station from among the pieces of point group data displayed on the screen, and output the selected candidate three-dimensional position to the candidate three-dimensional position selection unit 20. The candidate three-dimensional position selection unit 20 captures the three-dimensional position output from the operation processing unit 10, and determines the captured three-dimensional position as the candidate three-dimensional base station position data.

Next, the candidate three-dimensional position selection unit 20 reads from the two-dimensional visibility determination result storage unit 15 data indicating the visible range of the building associated with the captured candidate two-dimensional base station position data. The candidate three-dimensional position selection unit 20 reads from the point group data storage unit 13 point group data in the range indicated by the read data indicating the visible range of the building, and displays the read point group data on the screen. The user operates the operation processing unit 10 to select a candidate three-dimensional position for installing a terminal station from among the pieces of point group data displayed on the screen, and output the selected candidate three-dimensional position to the candidate three-dimensional position selection unit 20. The candidate three-dimensional position selection unit 20 captures the three-dimensional position output from the operation processing unit 10, and determines the captured three-dimensional position as the candidate three-dimensional terminal station position data. Hereinafter, the candidate three-dimensional base station position data shall be simply referred to as “candidate base station position data,” and the candidate three-dimensional terminal station position data shall be simply referred to as “candidate terminal station position data.”

The positional relationship identification unit 21 performs, for each combination of the candidate base station position data and the candidate terminal station position data selected by the candidate three-dimensional position selection unit 20, generation of base station positional relationship identification data indicating the positional relationship between the travel trajectory and the candidate base station position, and terminal station positional relationship identification data indicating the positional relationship between the travel trajectory and the candidate terminal station position based on the travel trajectory data stored in the travel trajectory data storage unit 14.

The confidence coefficient identification unit 22 performs, based on the base station positional relationship identification data and the terminal station positional relationship identification data generated by the positional relationship identification unit 21, identification of a confidence coefficient indicating the degree of reliability of the processing result of a predetermined evaluation process performed based on the point group data. Herein, the predetermined evaluation process is a three-dimensional visibility determination process performed by the three-dimensional visibility determination processing unit 23 or a shield factor calculation process performed by the shield factor calculation unit 24.

The confidence coefficient identification unit 22 outputs the identified confidence coefficient together with a combination of the candidate base station position data and the candidate terminal station position data corresponding to the confidence coefficient (step S5-1). The confidence coefficient identification unit 22 can, by presenting the confidence coefficient to the user of the station deployment support apparatus 1, allow the user to recognize the degree of reliability of the processing result of a predetermined evaluation process for each combination of the candidate base station position and the candidate terminal station position.

The three-dimensional visibility determination processing unit 23 reads from the point group data storage unit 13 point group data of a space between the candidate base station position and the candidate terminal station position respectively indicated by the candidate base station position data and the candidate terminal station position data selected by the candidate three-dimensional position selection unit 20 (step S5-2). Then, the three-dimensional visibility determination processing unit 23 performs a three-dimensional visibility determination process for the space between the candidate base station position and the candidate terminal station position based on the read point group data, using a means disclosed in Reference 2 (Japanese Patent Application No. 2019-001401), for example, and estimates if communication is possible based on the result of the determination process (step S5-3).

In contrast, when the point group data processing unit 6 calculates the shield factor, the shield factor calculation unit 24 reads from the point group data storage unit 13 point group data of the space between the candidate base station position and the candidate terminal station position respectively indicated by the candidate base station position data and the candidate terminal station position data selected by the candidate three-dimensional position selection unit 20 (step S5-2). Then, the shield factor calculation unit 24 calculates the shield factor of the space between the candidate base station position and the candidate terminal station position based on the read point group data, using a means disclosed in Reference 3 (Japanese Patent Application No. 2019-242831), for example, and estimates if communication is possible based on the result of the calculation process (step S5-3). The point group data processing unit 6 performs the process of steps S5-1 to S5-3 for all combinations of the candidate base station position data and the candidate terminal station position data.

The number-of-stations calculation unit 7 counts the candidate base station positions and the candidate terminal station positions based on the result of estimation of if communication is possible, which has been performed by the point group data processing unit 6 using the three-dimensional point group data, and calculates the required number of base stations and the number of terminal stations to be accommodated for each candidate base station position (step S6-1).

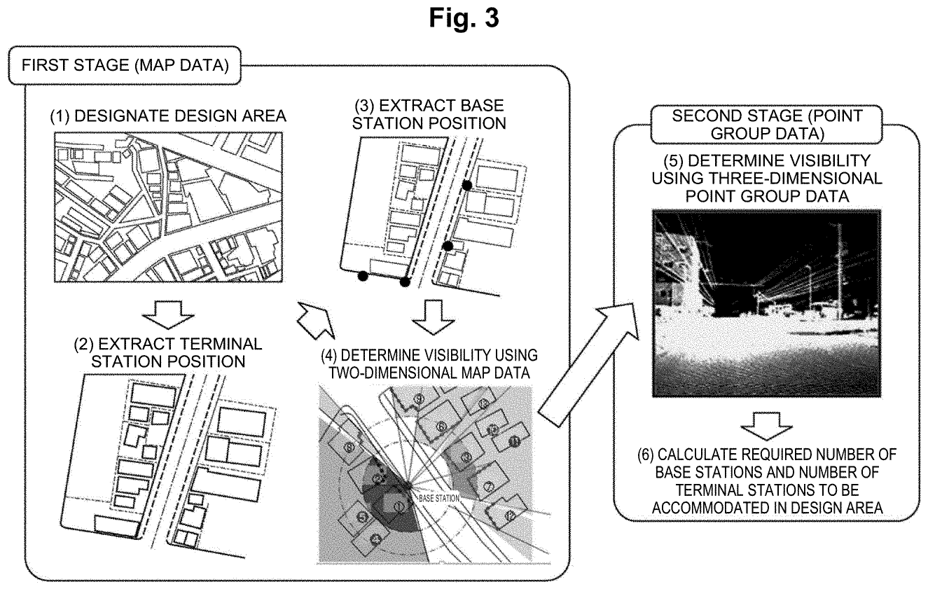

The configuration of the process performed by the station deployment support apparatus 1 can also be regarded as a two-stage process that includes a process performed using map data as two-dimensional data, and a process performed using point group data as three-dimensional data in response to the result of the first-stage process as illustrated in FIG. 3.

As illustrated in FIG. 3, the first-stage process performed using map data as two-dimensional data includes four processes: (1) designating a design area, (2) extracting a candidate terminal station position, (3) extracting a candidate base station position, and (4) determining visibility using the two-dimensional map data.

The process (1) of designating a design area corresponds to the process of steps S1-1 and S1-2 performed by the design area designation unit 2. The process (2) of extracting a candidate terminal station position corresponds to the process of step S2-1 performed by the candidate terminal station position extraction unit 4. The process (3) of extracting a candidate base station position corresponds to the process of step S3-1 performed by the candidate base station position extraction unit 3. The process (4) of determining visibility using the two-dimensional map data corresponds to the process of steps S4-1 to S4-4 performed by the two-dimensional visibility determination processing unit 5.

The second-stage process performed using point group data as three-dimensional data includes two processes: (5) determining if communication is possible using three-dimensional point group data, and (6) calculating the required number of base stations and the number of terminal stations to be accommodated in the design area.

The process (5) of determining if communication is possible using three-dimensional point group data corresponds to the process of steps S5-1 to S5-3 performed by the point group data processing unit 6. The process (6) of calculating the required number of base stations and the number of terminal stations to be accommodated in the design area corresponds to the process of step S6-1 performed by the number-of-stations calculation unit 7.

For example, regarding a base station to be installed in an outdoor facility, such as a utility pole, and a terminal station to be installed on a wall surface of a building for performing millimeter-wave wireless communication, it is possible to support the station deployment design by determining the three-dimensional visibility of a space between a candidate base station position and a candidate terminal station position using three-dimensional point group data. To handle three-dimensional point group data, an enormous volume of data and enormous computer resources are needed. Therefore, the station deployment support apparatus 1 is configured such that before the three-dimensional point group data is utilized, the two-dimensional visibility determination processing unit 5 determines the two-dimensional visibility of a space between a candidate base station position and a candidate terminal station position, and the point group data processing unit 6 narrows the point group data to be utilized using the result of the determination so as to perform a three-dimensional visibility determination process. Therefore, it is possible to perform an efficient three-dimensional visibility determination process with reduced computer resources.

For wireless communication, it is important to not only determine simple linear visibility, but also calculate the “shield factor” of a spheroidal region, that is, a so-called Fresnel zone between transmission and reception related to the propagation of radio waves through a space. The point group data processing unit 6 in the station deployment support apparatus 1 includes the shield factor calculation unit 24 to calculate the shield factor. For calculation of the shield factor, more computer resources are needed than those for a three-dimensional visibility determination process. However, since the point group data to be utilized has been sufficiently narrowed through the two-dimensional visibility determination process performed by the two-dimensional visibility determination processing unit 5 in the station deployment support apparatus 1, it is possible to perform an efficient shield factor calculation process with reduced computer resources.

In the station deployment support apparatus 1 of the first embodiment, the positional relationship identification unit 21 performs, based on travel trajectory data indicating the travel trajectory of a mobile object that travels and measures an object present in a three-dimensional space within a predetermined measurable distance, and then acquires point group data indicating the position of the measured object in the three-dimensional space, the measurable distance, candidate base station position data indicating a candidate position for installing a base station apparatus, and candidate terminal station position data indicating a candidate position for installing a terminal station apparatus, generation of base station positional relationship identification data that indicates the positional relationship between the travel trajectory and the candidate base station position, and terminal station positional relationship identification data that indicates the positional relationship between the travel trajectory and the candidate terminal station position. The confidence coefficient identification unit 22 is configured to, based on the base station positional relationship identification data and the terminal station positional relationship identification data generated by the positional relationship identification unit 21, identify a confidence coefficient indicating the degree of reliability of the processing result of a predetermined evaluation process performed based on the point group data.

Accordingly, the confidence coefficient identification unit 22 can present to the user the confidence coefficient indicating the degree of reliability of the processing result of a predetermined evaluation process performed based on the point group data, for each candidate base station position and each candidate terminal station position. Therefore, when not all pieces of point group data have been acquired from the space between the candidate base station position and the candidate terminal station position, the reliability of the point group data is low, and in such a case, it is possible to allow the user to recognize from the confidence coefficient that the reliability of the processing result of a predetermined evaluation process performed using such point group data is also low.

For example, suppose that not all pieces of point group data have been acquired, but the three-dimensional visibility determination processing unit 23 indicates “visible” as a result of a determination process or the shield factor calculation unit 24 indicates “a sufficiently low shield factor that meets the requirement for wireless communication” as a result of a calculation process. Even in such a case, it is possible to urge the user to take precautions by presenting a confidence coefficient with a small value. Accordingly, it is possible to prevent the user from making erroneous determination, for example, selecting candidate positions for installing a base station and a terminal station in a space from which point group data, which serves as a basis for three-dimensional visibility determination or shield factor calculation, has not been acquired.

In addition, identifying the confidence coefficient can prompt the user to make the following determination depending on whether the value of the confidence coefficient is large or small. For example, suppose that not all pieces of point group data have been acquired from the space between the candidate base station position and the candidate terminal station position, but the value of the confidence coefficient is large. In such a case, it is possible to prompt the user to, regarding the combination of the candidate base station position and the candidate terminal station position to be considered, determine that consideration using the acquired point group data is possible.

Further, identifying the confidence coefficient can also allow the three-dimensional visibility determination processing unit 23 to determine whether to perform a three-dimensional visibility determination process or allow the shield factor calculation unit 24 to determine whether to calculate the shield factor depending on whether the value of the confidence coefficient is large or small. For example, the three-dimensional visibility determination processing unit 23 or the shield factor calculation unit 24 may be configured to, when the value of the confidence coefficient is small, not perform a process for a combination of the candidate base station position and the candidate terminal station position as the processing targets, so that the amount of calculation can be reduced. Further, when the user is notified of the fact that the three-dimensional visibility determination processing unit 23 or the shield factor calculation unit 24 has not performed a process, the user can be prompted to acquire point group data again from the space between the candidate base station position and the candidate terminal station position as the processing targets or reconsider the candidate base station position and the candidate terminal station position. Therefore, even when the state of acquisition of point group data from the space between the candidate base station position and the candidate terminal station position is not good, the user can perform appropriate station deployment design.

### Second Embodiment

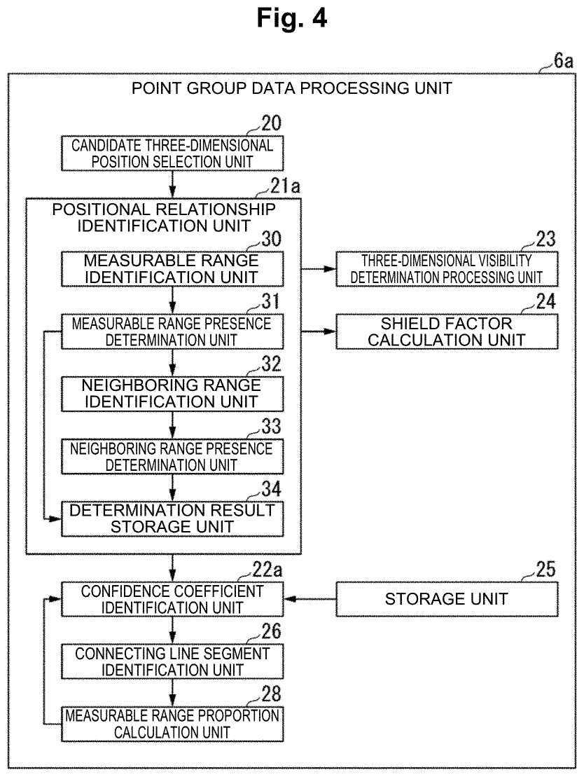

FIG. 4 is a block diagram illustrating the internal configuration of a point group data processing unit 6a applied to the second embodiment. In the second embodiment, components identical to those of the first embodiment are denoted by identical reference signs. In the following description, a station deployment support apparatus of the second embodiment shall be referred to as a station deployment support apparatus 1a with a reference sign “la” added thereto, though not illustrated in the drawings. The station deployment support apparatus 1a has a configuration obtained by replacing the point group data processing unit 6 in the station deployment support apparatus 1 of the first embodiment with the point group data processing unit 6a illustrated in FIG. 4.

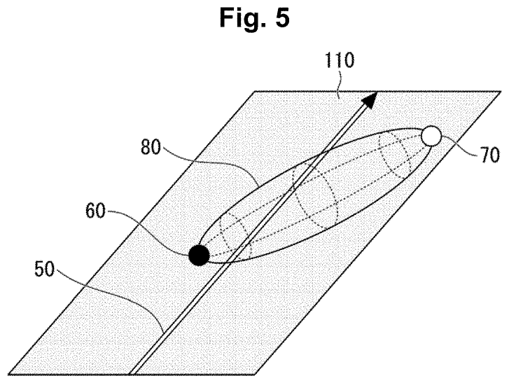

First, the relevance of a confidence coefficient identified in the second embodiment to the positional relationship among the travel trajectory of a mobile object, such as a vehicle, having an MMS mounted thereon, a candidate base station position, and a candidate terminal station position will be described with reference to FIGS. 5 to 14.

In FIG. 5, an arrowed line segment indicated by reference sign 50 is the travel trajectory indicated by the travel trajectory data stored in the travel trajectory data storage unit 14, and indicates that a mobile object, such as a vehicle, having an MMS mounted thereon has traveled in the direction of the arrow. The MMS irradiates a surrounding space with a laser radar beam to measure the reflection of the laser radar beam from the object, and then records data on the direction in which the object is present as well as the distance from the object. Point group data is generated through the operation of converting the recorded data on the direction and the distance into the coordinates of the three-dimensional space. Herein, there is a limitation on the distance within which data on the direction and the distance can be obtained with a laser radar beam emitted from the MMS, and such a limitation is referred to as a measurable distance. The measurable distance is the distance determined by the performance of the MMS and is a known value.

A planar region indicated by reference sign 110 is a region indicating the measurable range of a laser radar beam emitted from the MMS for measurement purposes, and is a region having, on the opposite sides of the line segment of the travel trajectory 50 as the center, areas each corresponding to the length of the measurable distance of the MMS. Hereinafter, such a region shall be referred to as a measurable range 110.

In FIG. 5, a candidate base station position 60 indicated by candidate base station position data and a candidate terminal station position 70 indicated by candidate terminal station position data are located on the opposite sides of the travel trajectory 50, and both the candidate base station position 60 and the candidate terminal station position 70 are included in a space obtained by expanding the measurable range 110 in the vertical direction. In other words, both the candidate base station position 60 on the two-dimensional plane for which the vertical coordinate components are ignored and the candidate terminal station position 70 on the two-dimensional plane for which the vertical coordinate components are ignored are located within the measurable range 110.

It should be noted that in practice, a space in a sphere that has the MMS as the center and has the measurable distance as the radius corresponds to the measurable range. In addition, regarding an MMS that moves straight, a space in a cylinder that has the travel trajectory 50 as the center and has the measurable distance as the radius corresponds to the measurable range. However, usually, any of such measurable ranges has a measurable distance with a sufficiently large value in the horizontal direction in comparison with the altitude at which a base station apparatus is installed (on a utility pole, for example) and the altitude at which a terminal station apparatus is installed (on a wall surface of a building). Therefore, when the candidate base station position 60 and the candidate terminal station position 70 on the two-dimensional plane for which the vertical coordinate components are ignored are located within the measurable range 110, it follows that the candidate base station position 60 and the candidate terminal station position 70 are also located within the measurable range in the three-dimensional space.

Hereinafter, the fact that the candidate base station position 60 or the candidate terminal station position 70 is included in the space obtained by expanding the measurable range 110 in the vertical direction is referred to as follows: “the candidate base station position 60 or the candidate terminal station position 70 is located within the measurable range 110.” In contrast, the fact that the candidate base station position 60 or the candidate terminal station position 70 is not included in the space obtained by expanding the measurable range 110 in the vertical direction is referred to as follows: “the candidate base station position 60 or the candidate terminal station position 70 is located outside the measurable range 110.”

A spheroid indicated by reference sign 80 is a Fresnel zone representing a region in which radio waves propagate. The Fresnel zone is formed when a wireless communication device is installed at each of the candidate base station position 60 and the candidate terminal station position 70. When there is any point group data in the Fresnel zone 80, it is highly probable that such a zone is determined to be not visible. In addition, the shield factor becomes high.

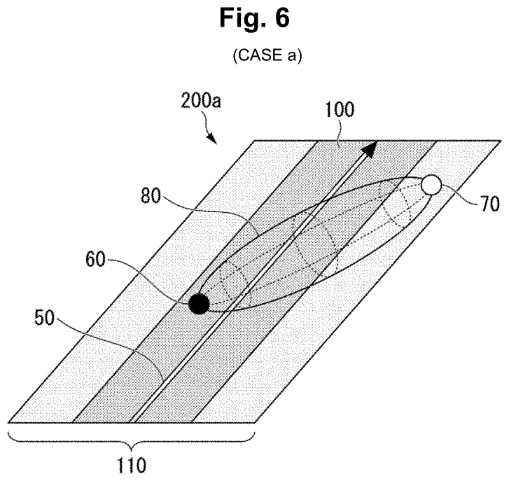

FIG. 6 is a view obtained by adding a planar region indicated by reference sign 100 to FIG. 5. The planar region indicated by reference sign 100 is a region having, on the opposite sides of the line segment of the travel trajectory 50 as the center, areas each corresponding to the length of the neighbor distance determined in advance that is shorter than the measurable distance of the MMS determined in advance. Hereinafter, such a region shall be referred to as a neighboring range 100. For example, the neighbor distance may be determined in advance as a length corresponding to about half the width of a road in the evaluation target range on which a vehicle or the like having an MMS mounted thereon travels.

As illustrated in FIG. 6, the candidate base station position 60 is included in a space obtained by expanding the neighboring range 100 in the vertical direction. In contrast, the candidate terminal station position 70 is not included in the space obtained by expanding the neighboring range 100 in the vertical direction. In other words, the candidate base station position 60 on the two-dimensional plane for which the vertical coordinate components are ignored is located within the neighboring range 100. Meanwhile, the candidate terminal station position 70 on the two-dimensional plane for which the vertical coordinate components are ignored is located outside the neighboring range 100.

Hereinafter, the fact that the candidate base station position 60 or the candidate terminal station position 70 is included in the space obtained by expanding the neighboring range 100 in the vertical direction is referred to as follows: “the candidate base station position 60 or the candidate terminal station position 70 is located within the neighboring range 100.” In contrast, the fact that the candidate base station position 60 or the candidate terminal station position 70 is not included in the space obtained by expanding the neighboring range 100 in the vertical direction is referred to as follows: “the candidate base station position 60 or the candidate terminal station position 70 is located outside the neighboring range 100.”

As illustrated in FIG. 6, a case where both the candidate base station position 60 and the candidate terminal station position 70 are located within the measurable range 110 shall be hereinafter referred to as a “case a,” and the positional relationship of the “case a” shall be hereinafter referred to as a positional relationship configuration 200a.

In the “case a,” both the candidate base station position 60 and the candidate terminal station position 70 are located within the measurable range 110. Therefore, it is considered that all pieces of point group data in the space between the candidate base station position 60 and the candidate terminal station position 70 can be acquired unless some are missed during the measurement process. Therefore, it is estimated that the processing result of a three-dimensional visibility determination process of the three-dimensional visibility determination processing unit 23 and the processing result of a shield factor calculation process of the shield factor calculation unit 24, each performed based on the acquired point group data, are high reliable. Thus, it is considered that it makes sense to perform such a process with the three-dimensional visibility determination processing unit 23 or the shield factor calculation unit 24.

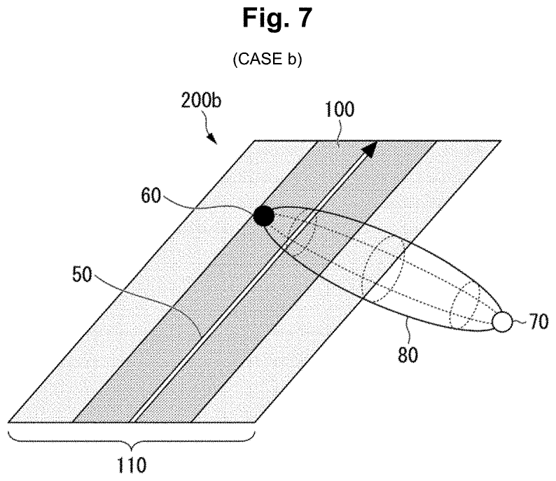

In a “case b” indicated by a positional relationship configuration 200b illustrated in FIG. 7, the candidate base station position 60 is located within the measurable range 110 and the neighboring range 100, while the candidate terminal station position 70 is located outside the measurable range 110. In this manner, when one of the candidate base station position 60 and the candidate terminal station position 70 is located outside the measurable range 110, some pieces of point group data in the space between the two wireless stations cannot be acquired. In such a case, it is estimated that the processing result of a three-dimensional visibility determination process or the processing result of a shield factor calculation process is less reliable than in the “case a.”

However, even in the “case b,” when the processing result of a three-dimensional visibility determination process performed by the three-dimensional visibility determination processing unit 23 based on the acquired point group data indicates “not visible” or when the processing result of a shield factor calculation process performed by the shield factor calculation unit 24 based on the acquired point group data indicates a “high shield factor,” such a result actually serves as reference information for the user to determine that the propagation environment is not better than the obtained result. Therefore, although there is a need to warn the user about low reliability, it is considered that it makes some sense to perform the aforementioned process with the three-dimensional visibility determination processing unit 23 or the shield factor calculation unit 24.

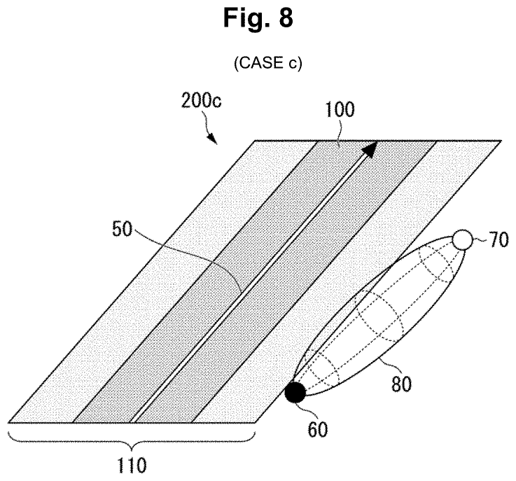

In a “case c” of a positional relationship configuration 200c illustrated in FIG. 8, both the candidate base station position 60 and the candidate terminal station position 70 are located outside the measurable range 110. In such a case, it is impossible to acquire point group data from the space between the candidate base station position 60 and the candidate terminal station position 70. Therefore, it is nonsense to perform a three-dimensional visibility determination process of the three-dimensional visibility determination processing unit 23 or a shield factor calculation process of the shield factor calculation unit 24 that should be performed based on point group data. Even if such a process is performed, it is estimated that the obtained processing result has quite low reliability. Therefore, in the “case c,” it is considered desirable not to perform a process with the three-dimensional visibility determination processing unit 23 or the shield factor calculation unit 24 and to present to the user information indicating “process impossible” such as “visibility determination impossible” or “shield factor calculation impossible.”

As described with reference to the three cases of the “case a” to the “case c” illustrated in FIGS. 6 to 8, the state of acquisition of point group data, which is present in the space between the candidate base station position 60 and the candidate terminal station position 70, differs from case to case. Thus, the reliability of the acquired point group data also differs from case to case. In this manner, since point group data with difference reliability is utilized, the reliability of the processing result of a three-dimensional visibility determination process or a shield factor calculation process for the space between the candidate base station position 60 and the candidate terminal station position 70 also differs depending on the reliability of the point group data.

Therefore, when the degree of reliability of the pressing result of a predetermined evaluation process performed based on the acquired point group data is presented to the user of the station deployment support apparatus 1a in an easily understandable way using a confidence coefficient, the processing result of the predetermined evaluation process can be actually utilized for installing a base station and a terminal station if the confidence coefficient has a large value, for example. In contrast, if the confidence coefficient has a small value, it is possible to prompt the user to acquire point group data again or reconsider the positions of the candidate base station position 60 and the candidate terminal station position 70.

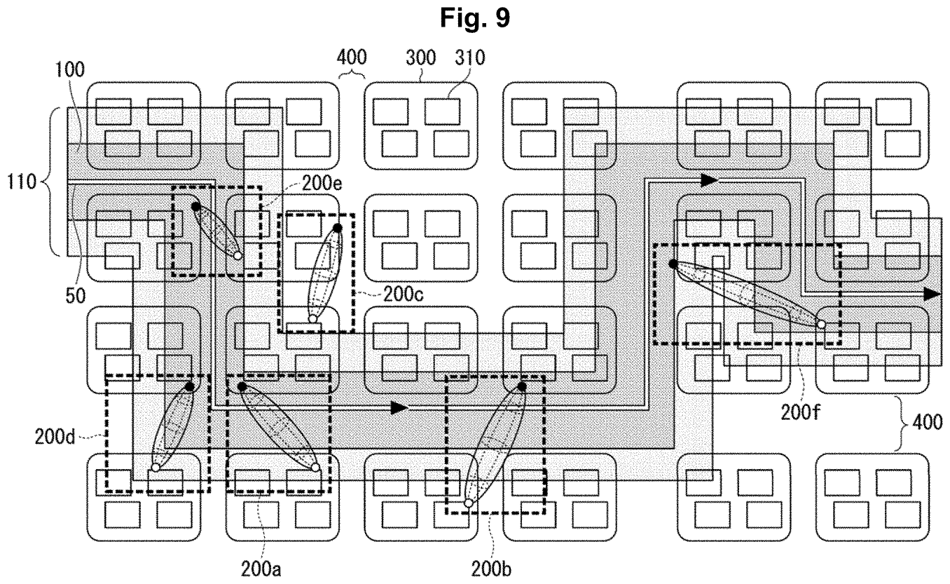

The reliability of point group data is determined by the positional relationship among the candidate base station position 60, the candidate terminal station position 70, and the travel trajectory 50. FIG. 9 illustrates a case where the reliability of point group data is different other than the three cases illustrated in FIGS. 6 to 8.

FIG. 9 is a view representing a map of an urban area. A region of a road 400 is illustrated in a lattice pattern. Each of a plurality of regions partitioned in a lattice pattern by the regions of the road 400 is a site 300. Each site 300 includes a plurality of buildings 310 indicated by a rectangular shape.

FIG. 9 also illustrates the travel trajectory 50 of a mobile object, such as a vehicle, having an MMS mounted thereon, and the neighboring range 100 and the measurable range 110 are illustrated along the travel trajectory 50. As seen in FIG. 9, the measurable range 110 does not cover the entire urban area.

FIG. 9 also illustrates the “case a” represented by the positional relationship configuration 200a illustrated in FIG. 6, the “case b” represented by the positional relationship configuration 200b illustrated in FIG. 7, and the “case c” represented by the positional relationship configuration 200c illustrated in FIG. 8. FIG. 9 further illustrates, in addition to such three cases, a “case d” represented by a positional relationship configuration 200d, a “case e” represented by a positional relationship configuration 200e, and a “case f” represented by a positional relationship configuration 200f.

In the “case d,” both the candidate base station position 60 and the candidate terminal station position 70 are located within the measurable range 110, and the candidate base station position 60 is further located within the neighboring range 100. When the “case d” and the “case a” are compared, the “case d” differs from the “case a” in that the candidate base station position 60 indicated by a solid circle “•” and the candidate terminal station position 70 indicated by a hollow circle “∘” that are included in the positional relationship configuration 200d are present on one side of the travel trajectory 50.

In the “case e,” both the candidate base station position 60 indicated by a solid circle “•” and the candidate terminal station position 70 indicated by a hollow circle “∘” that are included in the positional relationship configuration 200e are located within the neighboring range 100. Therefore, the Fresnel zone 80 is also located within the neighboring range 100. Thus, in the “case e,” it is considered that point group data with further higher reliability than that in the “case a” can be acquired. Thus, in the “case e,” it can be estimated that the processing result of a three-dimensional visibility determination process of the three-dimensional visibility determination processing unit 23 and the processing result of a shield factor calculation process of the shield factor calculation unit 24, each performed based on the acquired point group data, have further higher reliability than in the “case a.”

In the “case f,” both the candidate base station position 60 indicated by a solid circle “•” and the candidate terminal station position 70 indicated by a hollow circle “∘” that are included in the positional relationship configuration 200f are located within the neighboring range 100 as in the “case e.” However, the “case f” differs from the “case e” in that a part of the Fresnel zone 80 is located neither within the neighboring range 100 nor within the measurable range 110. Therefore, in the “case f,” it is considered that the reliability of the point group data that can be acquired is lower than that in the “case e.” Thus, in the “case f,” it can be estimated that the processing result of a three-dimensional visibility determination process of the three-dimensional visibility determination processing unit 23 and the processing result of a shield factor calculation process of the shield factor calculation unit 24, each performed based on the acquired point group data, is less reliable than in the “case e.”

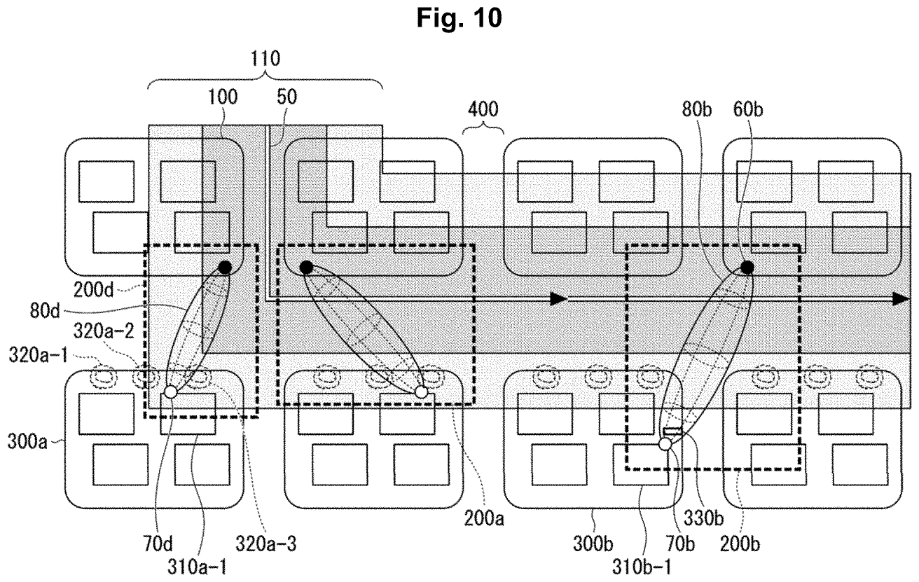

Next, referring to FIG. 10, further consideration of the reliability of point group data will be described using the “case b” and the “case d.” FIG. 10 is an enlarged view of a region including the positional relationship configuration 200a, the positional relationship configuration 200b, and the positional relationship configuration 200d in FIG. 9. It should be noted that FIG. 10 illustrates not only the enlarged view of FIG. 9 but also trees 320a-1 to 320a-3, a signboard 330b, and the like that are omitted in FIG. 9.

It should be noted that in FIGS. 10 to 12, to illustrate the candidate base station position 60, the candidate terminal station position 70, and the Fresnel zone 80 for each case, reference signs “b” and “d” of the “case b” and the “case d” are added to their reference signs. In addition, to distinguish among the sites 300 and the buildings 310, different alphabetical characters or branch numbers are added thereto for convenience's sake.

As described above, in the “case b,” the candidate base station position 60b is located within the measurable range 110 and the neighboring range 100. The candidate terminal station position 70b is located on a wall surface of a building 310b-1 in a site 300b, and such a position is outside the measurable range 110. Point group data has not been acquired outside the measurable range 110. As illustrated in FIG. 10, the signboard 330b, which has a shop name and the like printed thereon, is present near the candidate terminal station position 70b and at a position shielding the Fresnel zone 80b. Since the signboard 330b is not located within the measurable range 110, point group data on the signboard 330b has not been acquired.

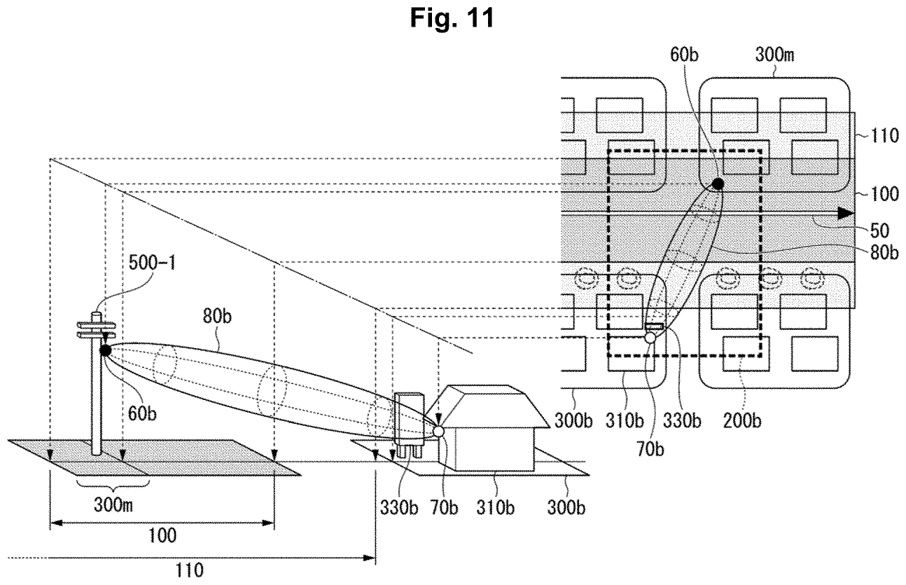

FIG. 11 illustrates a plan view of a region including the positional relationship configuration 200b illustrated in FIG. 10, and a bird's-eye view illustrating the region three-dimensionally. In the plan view and the bird's-eye view, corresponding objects, positions, and the like are denoted by identical reference signs. As seen in FIG. 11, the signboard 330b is located at a position shielding the Fresnel zone 80b and at a position outside the measurable range 110. In such a case, the acquired point group data does not include the point group data on the signboard 330b. Thus, in a three-dimensional visibility determination process performed by the three-dimensional visibility determination processing unit 23, erroneous determination of “being visible” may be made. In addition, in a shield factor calculation process performed by the shield factor calculation unit 24, a “low shield factor” may be obtained. In such a case, the user of the station deployment support apparatus 1a may make erroneous determination.

Meanwhile, suppose that a processing result of “being not visible” is obtained in a three-dimensional visibility determination process performed by the three-dimensional visibility determination processing unit 23 based on the acquired point group data or a processing result of a “high shield factor” is obtained in a shield factor calculation process performed by the shield factor calculation unit 24 based on the acquired point group data. In such a case, it can be said that the obtained processing result is a correct processing result. In this regard, even in the “case b,” it can be said that the processing result of a three-dimensional visibility determination process and the processing result of a shield factor calculation process have passable reliability.

In the “case d” represented by the positional relationship configuration 200d illustrated in FIG. 10, the candidate terminal station position 70d is located on a wall surface of a building 310a-1, and a site 300a of the building 310a-1 is planted with trees 320a-1, 320a-2, and 320a-3, such as roadside trees or garden trees. Among them, the tree 320a-3 is located at a position shielding the Fresnel zone 80d between the candidate base station position 60d and the candidate terminal station position 70d.

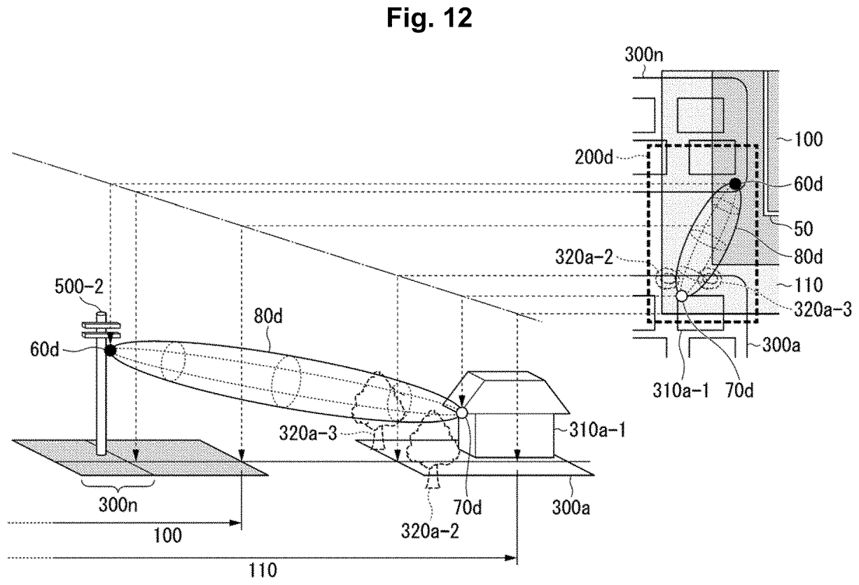

FIG. 12 illustrates a plan view of a region including the positional relationship configuration 200d illustrated in FIG. 10, and a bird's-eye view illustrating the region three-dimensionally. In the plan view and the bird's-eye view, corresponding objects, positions, and the like are denoted by identical reference signs. As seen in FIG. 12, the tree 320a-3 is located at a position shielding the Fresnel zone 80d and within the measurable range 110. Since the tree 320a-3 is located within the measurable range 110, point group data thereon has been acquired.

Typically, point group data on a tree, in particular, point group data on portions of branches and leaves of a tree include many gaps. For example, the thickness of leaves is about several [mm], while the interval of acquisition of point group data when a tree is not near the travel trajectory 50 is several [cm] to several tens of [cm], for example. Therefore, the acquired point group data on the tree includes many gaps depending on the density of branches and leaves of the tree.

When the three-dimensional visibility determination processing unit 23 performs a three-dimensional visibility determination process based on point group data including many gaps, a processing result of “being visible” may be obtained. In addition, when the shield factor calculation unit 24 performs a shield factor calculation process based on point group data including many gaps, a processing result of a “low shield factor” may be obtained. In such cases, the user of the station deployment support apparatus 1a may make erroneous determination.

Meanwhile, suppose that a processing result of “being not visible” is obtained in a three-dimensional visibility determination process performed by the three-dimensional visibility determination processing unit 23 based on the acquired point group data, or a processing result of a “high shield factor” is obtained in a shield factor calculation process performed by the shield factor calculation unit 24 based on the acquired point group data. In such a case, it can be said that the obtained processing result is a correct processing result. In this regard, even in the “case d,” it can be said that the processing result of a three-dimensional visibility determination process and the processing result of a shield factor calculation process have passable reliability.

Herein, referring again to FIG. 4, the configuration of the point group data processing unit 6a of the second embodiment will be described. The point group data processing unit 6a includes the candidate three-dimensional position selection unit 20, the positional relationship identification unit 21a, the confidence coefficient identification unit 22a, the three-dimensional visibility determination processing unit 23, the shield factor calculation unit 24, a storage unit 25, a connecting line segment identification unit 26, and a measurable range proportion calculation unit 28.

The positional relationship identification unit 21a includes a measurable range identification unit 30, a measurable range presence determination unit 31, a neighboring range identification unit 32, a neighboring range presence determination unit 33, and a determination result storage unit 34. In the positional relationship identification unit 21a, the measurable range identification unit 30 generates measurable range data indicating the measurable range 110 based on the travel trajectory data stored in the travel trajectory data storage unit 14 and the measurable distance determined in advance.

The measurable range presence determination unit 31 determines if the candidate base station position 60 is present within the measurable range 110 based on the measurable range data generated by the measurable range identification unit 30 and the candidate base station position data selected by the candidate three-dimensional position selection unit 20. Then, the measurable range presence determination unit 31 generates base station positional relationship identification data indicating the determination result. The base station positional relationship identification data includes information indicating that the candidate base station position 60 is present within the measurable range 110 or information indicating that the candidate base station position 60 is present outside the measurable range 110. Then, the measurable range presence determination unit 31 writes and stores the thus generated base station positional relationship identification data into the determination result storage unit 34.

In addition, the measurable range presence determination unit 31 determines if the candidate terminal station position 70 is present within the measurable range 110 based on the measurable range data generated by the measurable range identification unit 30 and the candidate terminal station position data selected by the candidate three-dimensional position selection unit 20. Then, the measurable range presence determination unit 31 generates terminal station positional relationship identification data indicating the determination result. The terminal station positional relationship identification data includes information indicating that the candidate terminal station position 70 is present within the measurable range 110 or information indicating that the candidate terminal station position 70 is present outside the measurable range 110. Then, the measurable range presence determination unit 31 writes and stores the thus generated terminal station positional relationship identification data into the determination result storage unit 34.

The neighboring range identification unit 32 generates neighboring range data indicating the neighboring range 100 based on the travel trajectory data stored in the travel trajectory data storage unit 14 and the neighbor distance determined in advance. The neighboring range presence determination unit 33 determines if the candidate base station position 60 is present within the neighboring range 100 based on the neighboring range data generated by the neighboring range identification unit 32 and the candidate base station position data selected by the candidate three-dimensional position selection unit 20. Then, the neighboring range presence determination unit 33 adds information indicating the determination result to the base station positional relationship identification data. That is, the neighboring range presence determination unit 33 adds to the base station positional relationship identification data stored in the determination result storage unit 34 information indicating that the candidate base station position 60 is present within the neighboring range 100 or information indicating that the candidate base station position 60 is present outside the neighboring range 100.

In addition, the neighboring range presence determination unit 33 determines if the candidate terminal station position 70 is present within the neighboring range 100 based on the neighboring range data generated by the neighboring range identification unit 32 and the candidate terminal station position data selected by the candidate three-dimensional position selection unit 20. Then, the neighboring range presence determination unit 33 adds information indicating the determination result to the terminal station positional relationship identification data. That is, the neighboring range presence determination unit 33 adds to the terminal station positional relationship identification data stored in the determination result storage unit 34 information indicating that the candidate terminal station position 70 is present within the neighboring range 100 or information indicating that the candidate terminal station position 70 is present outside the neighboring range 100.

The storage unit 25 stores a confidence coefficient calculation logic in advance. The confidence coefficient calculation logic is information for the confidence coefficient identification unit 22a to calculate and identify a confidence coefficient indicating the degree of reliability of the processing result of a predetermined evaluation process performed based on point group data. The predetermined evaluation process is, as described above, a three-dimensional visibility determination process performed by the three-dimensional visibility determination processing unit 23 or a shield factor calculation process performed by the shield factor calculation unit 24.

The confidence coefficient identification unit 22a identifies a confidence coefficient indicating the degree of reliability of the processing result of a predetermined evaluation process performed based on point group data, based on the base station positional relationship identification data and the terminal station positional relationship identification data stored in the determination result storage unit 34 and the confidence coefficient calculation logic stored in the storage unit 25.

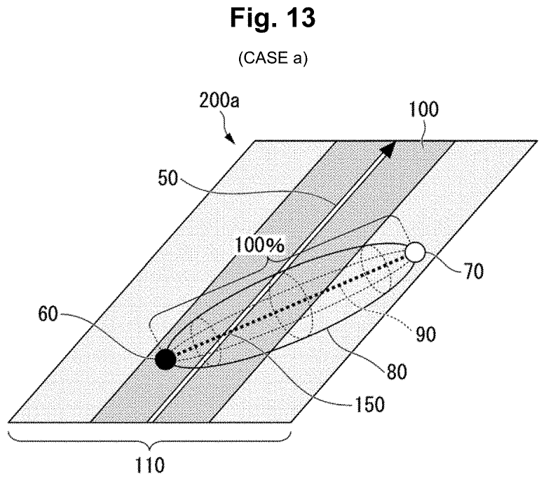

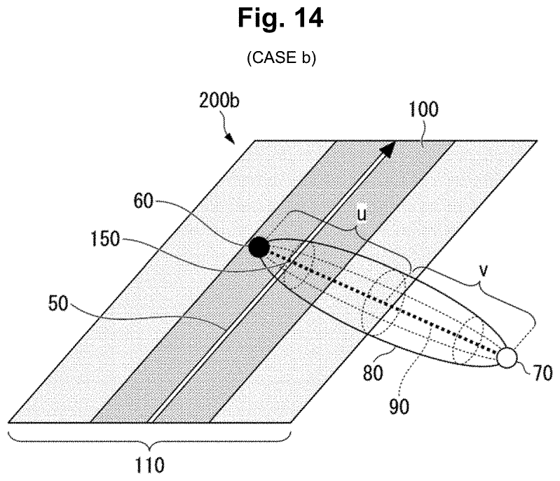

Herein, regarding a case where a connecting line segment 90 crosses the travel trajectory 50, the relationship between the proportion of the connecting line segment 90 included in the measurable range 110 and the reliability of point group data will be described through comparison between the “case a” of the positional relationship configuration 200a illustrated in FIG. 13 and the “case b” of the positional relationship configuration 200b illustrated in FIG. 14. As illustrated in FIG. 13, in the “case a,” the connecting line segment 90 connecting the candidate base station position 60 and the candidate terminal station position 70 is located within the measurable range 110 entirely, that is, at a proportion of 100[%].

In contrast, in the “case b” of the positional relationship configuration 200b illustrated in FIG. 14, the candidate base station position 60 is located within the neighboring range 100, while the candidate terminal station position 70 is located outside the measurable range 110 as described with reference to FIG. 7. In the “case b,” the candidate base station position 60 is located on the left side of the travel trajectory 50, while the candidate terminal station position 70 is located on the right side of the travel trajectory 50. Thus, the connecting line segment 90 crosses the travel trajectory 50. However, in the “case b,” a part of the connecting line segment 90 is located outside the measurable range 110. Therefore, although the connecting line segment 90 crosses the travel trajectory 50 in the “case b,” it is not appropriate to consider that the reliability of point group data obtained in the “case a” and the reliability of point group data obtained in the “case b” are equal.

Herein, as illustrated in FIG. 14, assume that the length of the connecting line segment 90 on the two-dimensional plane for which the vertical coordinate components are ignored, which is present within the measurable range 110, is “u,” and the length thereof outside the measurable range 110 is “v.” In such a case, the proportion X[%] of the connecting line segment 90 on the two-dimensional plane for which the vertical coordinate components are ignored, which is present within the measurable range 110, can be represented by the following Expression (1).

X=u/(u+v)×100[%] (1)

In the “case b,” regarding the “u” portion present within the measurable range 110, it can be said that the reliability of point group data that can be acquired is equal to the reliability of point group data that can be acquired in the “case a.”

In contrast, regarding the “v” portion present outside the measurable range 110, point group data cannot be acquired. Therefore, in the “case b,” when the overall point group data is considered, the reliability of the point group data is lower than that in the “case a.” In such a case, it is appropriate to consider that the degree of reliability of the processing result of a predetermined evaluation process drops to the proportion of the connecting line segment 90 present within the measurable range 110, that is, X[%]. In the present embodiment, the value of X in Expression (1) above is the confidence coefficient.

It should be noted that the connecting line segment 90 present within the measurable range 110 (that is, the range indicated by “u”) further includes a line segment located within the neighboring range 100 and a line segment located outside the neighboring range 100. The neighboring range 100 is a range closer to the travel trajectory 50 of a mobile object, such as a vehicle, having an MMS mounted thereon. Therefore, the inside of the neighboring range 100 is a range in which point group data can be collected with higher density than in the outside of the neighboring range 100, and thus the reliability is higher. Thus, for example, the aforementioned “u” that represents the length of the connecting line segment 90 on the two-dimensional plane for which the vertical coordinate components are ignored, which is present within the measurable range 110, may be further divided into a length “u₁” present within the neighboring range 100 and a length “u₂” present outside the neighboring range 100, and weighting may be applied such that the value of u₁ becomes larger than that of u₂. Accordingly, the accuracy of the value of the confidence coefficient X can be further increased.

Herein, referring again to FIG. 4, the configuration of the point group data processing unit 6a of the second embodiment will be described. The connecting line segment identification unit 26 generates connecting line segment data indicating the connecting line segment 90 connecting the candidate base station position 60 and the candidate terminal station position 70 based on the candidate base station position data indicating the candidate base station position 60 and the candidate terminal station position data indicating the candidate terminal station position 70.

The measurable range proportion calculation unit 28 calculates the proportion of the connecting line segment 90 present within the measurable range 110.

When the measurable range proportion calculation unit 28 has calculated the proportion X of the connecting line segment 90 present within the measurable range 110, the confidence coefficient identification unit 22a identifies the calculated proportion X as the confidence coefficient.

### Process of Second Embodiment

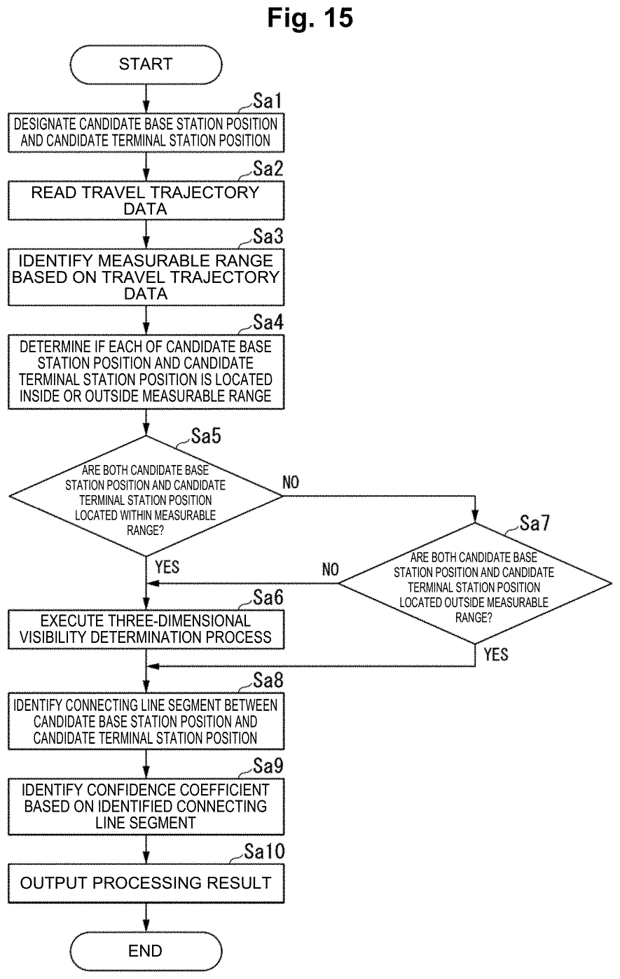

FIG. 15 is a flowchart illustrating a process flow of the point group data processing unit 6a of the second embodiment, and is a process corresponding to the (5) process of determining if communication is possible using three-dimensional point group data in the station deployment support method illustrated in FIG. 2. The flowchart of FIG. 15 illustrates an example in which a three-dimensional visibility determination process of the three-dimensional visibility determination processing unit 23 is applied as a predetermined evaluation process performed by the point group data processing unit 6a.

The candidate three-dimensional position selection unit 20 selects the candidate base station position 60 and the candidate terminal station position 70, and outputs to the positional relationship identification unit 21a candidate base station position data indicating the candidate base station position 60 and candidate terminal station position data indicating the candidate terminal station position 70 (step Sa1). Accordingly, the candidate base station position 60 and the candidate terminal station position 70 as processing targets are designated.

The measurable range identification unit 30 reads the travel trajectory data from the travel trajectory data storage unit 14 (step Sa2). Then, the measurable range identification unit 30 generates measurable range data indicating the measurable range 110 based on the read travel trajectory data and the measurable distance determined in advance (step Sa3). Then, the measurable range identification unit 30 outputs the generated measurable range data to the measurable range presence determination unit 31.

The measurable range presence determination unit 31 captures the candidate base station position data and the candidate terminal station position data output from the candidate three-dimensional position selection unit 20 and the measurable range data output from the measurable range identification unit 30. Then, the measurable range presence determination unit 31 determines if the candidate base station position 60 is located inside or outside the measurable range 110 based on the measurable range data and the candidate base station position data. Then, the measurable range presence determination unit 31 generates the determination result as base station positional relationship identification data, and writes and stores the generated base station positional relationship identification data into the determination result storage unit 34.

In addition, the measurable range presence determination unit 31 determines if the candidate terminal station position 70 is located inside or outside the measurable range 110 based on the measurable range data and the candidate terminal station position data. Then, the measurable range presence determination unit 31 generates the determination result as terminal station positional relationship identification data, and writes and stores the generated terminal station positional relationship identification data into the determination result storage unit 34 (step Sa4).

The measurable range presence determination unit 31 determines if the determination results indicate that both the candidate base station position 60 and the candidate terminal station position 70 are present within the measurable range 110 (step Sa5). If the measurable range presence determination unit 31 determines that the determination results indicate that both the candidate base station position 60 and the candidate terminal station position 70 are present within the measurable range 110 (step Sa5, Yes), the measurable range presence determination unit 31 outputs an instruction signal for instructing the three-dimensional visibility determination processing unit 23 to start a process including the candidate base station position data and the candidate terminal station position data as the processing targets.

In step Sa5, if the measurable range presence determination unit 31 determines “Yes,” the reliability of point group data is high. Thus, it makes sense to perform a three-dimensional visibility determination process.

The three-dimensional visibility determination processing unit 23, upon receiving the instruction signal from the measurable range presence determination unit 31, reads from the point group data storage unit 13 point group data of a space between the candidate base station position 60 corresponding to the candidate base station position data and the candidate terminal station position 70 corresponding to the candidate terminal station position data that are included in the instruction signal, and performs a three-dimensional visibility determination process based on the read point group data (step Sa6).

Meanwhile, if the measurable range presence determination unit 31 determines that the determination results indicate that at least one of the candidate base station position 60 or the candidate terminal station position 70 is not located within the measurable range 110 (step Sa5, No), the measurable range presence determination unit 31 determines if the determination results indicate that both the candidate base station position 60 and the candidate terminal station position 70 are present outside the measurable range 110 (step Sa7).

If the measurable range presence determination unit 31 determines that the determination results indicate that both the candidate base station position 60 and the candidate terminal station position 70 are present outside the measurable range 110 (step Sa7, Yes), the measurable range presence determination unit 31 proceeds with the process to step Sa8. If the measurable range presence determination unit 31 determines “Yes” in step Sa7, point group data has not been acquired from the space between the candidate base station position 60 and the candidate terminal station position 70. Therefore, since it is nonsense to perform a three-dimensional visibility determination process, the process of step Sa6 is not performed.

Meanwhile, if the measurable range presence determination unit 31 determines that the determination results indicate that one of the candidate base station position 60 and the candidate terminal station position 70 is present within the measurable range 110 (step Sa7, No), the measurable range presence determination unit 31 proceeds with the process to step Sa6. If the measurable range presence determination unit 31 determines “No” in step Sa7, it makes some sense to perform a three-dimensional visibility determination process. Therefore, the process of step Sa6 is performed.

It should be noted that among the aforementioned processes, the process of step Sa1 is performed by the candidate three-dimensional position selection unit 20, and the processes of steps Sa2 to Sa1 are performed by the positional relationship identification unit 21a.

The connecting line segment identification unit 26 captures the candidate base station position data and candidate terminal station position data output from the confidence coefficient identification unit 22a. Then, the connecting line segment identification unit 26 generates connecting line segment data indicating the connecting line segment 90 connecting the candidate base station position 60 and the candidate terminal station position 70 based on the captured candidate base station position data and candidate terminal station position data (step Sa8). Then, the connecting line segment identification unit 26 outputs the generated connecting line segment data to the measurable range proportion calculation unit 28.

The measurable range proportion calculation unit 28 captures the connecting line segment data output from the connecting line segment identification unit 26. Then, the measurable range proportion calculation unit 28 reads the travel trajectory data from the travel trajectory data storage unit 14, and calculates the length “u” of the connecting line segment 90 within the measurable range 110 and the length “v” of the connecting line segment 90 outside the measurable range 110 based on the read travel trajectory data, the connecting line segment data, and the measurable distance determined in advance.

The measurable range proportion calculation unit 28 calculates the proportion X[%] of the connecting line segment 90 on the two-dimensional plane for which the vertical coordinate components are ignored, which is present within the measurable range 110, using Expression (1). Then, the measurable range proportion calculation unit 28 outputs to the confidence coefficient identification unit 22a data on the calculated value of X[%] and an output instruction signal.

The confidence coefficient identification unit 22a in a standby state captures the data on the value of X[%] upon receiving the data on the value of X[%] and the output instruction signal from the measurable range proportion calculation unit 28. Then, the confidence coefficient identification unit 22a identifies the value of X[%] as the confidence coefficient (step Sa9).

The confidence coefficient identification unit 22a displays on a screen the candidate base station position data and the candidate terminal station position data stored in the determination result storage unit 34 of the positional relationship identification unit 21a as well as the confidence coefficient, and the three-dimensional visibility determination processing unit 23 displays on the screen the processing result of the three-dimensional visibility determination process (step Sa10). In contrast, when the process of step Sa6 has not been performed and thus the three-dimensional visibility determination processing unit 23 has not output a processing result, the confidence coefficient identification unit 22a displays on the screen the candidate base station position data and the candidate terminal station position data as well as the confidence coefficient, and also displays information that “it has been impossible to perform a three-dimensional visibility determination process” (step Sa10).

It should be noted that in the flowchart illustrated in FIG. 15, although a three-dimensional visibility determination process of the three-dimensional visibility determination processing unit 23 is used as a predetermined evaluation process, a shield factor calculation process of the shield factor calculation unit 24 may be used instead.

In addition, in the processes of steps Sa8 and Sa9 that are performed based on the connecting line segment 90 in the previously described flowchart in FIG. 15, the confidence coefficient may be identified by not only considering the proportion of the connecting line segment 90 present within the measurable range 110 but also considering the proportion of the connecting line segment 90 present within the neighboring range 100.

In the station deployment support apparatus of the second embodiment, the connecting line segment identification unit 26 generates connecting line segment data indicating the connecting line segment 90 connecting the candidate base station position 60 and the candidate terminal station position 70 based on the candidate base station position data and the candidate terminal station position data. The confidence coefficient identification unit 22a identifies the confidence coefficient X indicating the degree of reliability of the processing result of a predetermined evaluation process performed based on point group data, based on the proportion of the connecting line segment 90 present within the measurable range 110.

Accordingly, the confidence coefficient identification unit 22 can present to the user the confidence coefficient indicating the degree of reliability of the processing result of a predetermined evaluation process performed based on the point group data, for each candidate base station position and each candidate terminal station position. Therefore, when not all pieces of point group data have been acquired from the space between the candidate base station position and the candidate terminal station position, the reliability of the point group data is low, and in such a case, it is possible to allow the user to recognize from the confidence coefficient that the reliability of the processing result of a predetermined evaluation process performed using the point group data is also low.

For example, suppose that not all pieces of point group data have been acquired, but the three-dimensional visibility determination processing unit 23 indicates “visible” as a result of a determination process or the shield factor calculation unit 24 indicates “a sufficiently low shield factor that meets the requirement for wireless communication” as a result of a calculation process. Even in such a case, it is possible to urge the user to take precautions by presenting a confidence coefficient with a small value. Accordingly, it is possible to prevent the user from making erroneous determination, for example, selecting candidate positions for installing a base station and a terminal station in a space from which point group data, which serves as a basis for three-dimensional visibility determination or shield factor calculation, has not been acquired.

In addition, identifying the confidence coefficient can prompt the user to make the following determination depending on whether the value of the confidence coefficient is large or small. For example, suppose that not all pieces of point group data have been acquired from the space between the candidate base station position and the candidate terminal station position, but the value of the confidence coefficient is large. In such a case, it is possible to prompt the user to, regarding the combination of the candidate base station position and the candidate terminal station position to be considered, determine that consideration using the acquired point group data is possible.

Further, identifying the confidence coefficient can also allow the three-dimensional visibility determination processing unit 23 to determine whether to perform a three-dimensional visibility determination process or allow the shield factor calculation unit 24 to determine whether to calculate the shield factor depending on whether the value of the confidence coefficient is large or small. For example, the three-dimensional visibility determination processing unit 23 or the shield factor calculation unit 24 may be configured to, when the value of the confidence coefficient is small, not perform a process for a combination of the candidate base station position and the candidate terminal station position as the processing targets, so that the amount of calculation can be reduced. Further, when the user is notified of the fact that the three-dimensional visibility determination processing unit 23 or the shield factor calculation unit 24 has not performed a process, the user can be prompted to acquire point group data again from the space between the candidate base station position and the candidate terminal station position as the processing targets or reconsider the candidate base station position and the candidate terminal station position. Therefore, even when the state of acquisition of point group data from the space between the candidate base station position and the candidate terminal station position is not good, the user can perform appropriate station deployment design.

### Third Embodiment

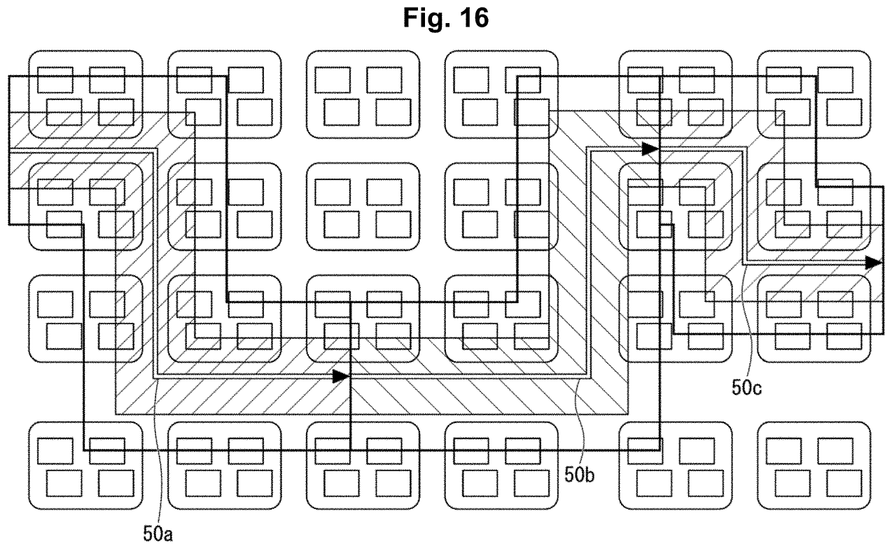

As illustrated in FIG. 9 described previously, when a mobile object, such as a vehicle, having an MMS mounted thereon travels from one end to the other end of an urban area at once to perform station deployment design for all combinations of the candidate base station position 60 and the candidate terminal station position 70, an enormous amount of calculation is required. In contrast, FIG. 16 is a view illustrating a plurality of travel sections and a plurality of travel trajectories 50 (50a, 50b, and 50c) of a mobile object, such as a vehicle, having an MMS mounted thereon in a third embodiment. In the present embodiment, as illustrated in FIG. 16, a mobile object, such as a vehicle, having an MMS mounted thereon travels the travel sections one by one. The mobile object, such as a vehicle, having an MMS mounted thereon further travels a new travel section as appropriate.

Alternatively, the mobile object, such as a vehicle, having an MMS mounted thereon may travel from one end to the other end of an urban area at once as in FIG. 9 described previously, and the station deployment support apparatus 1 may perform station deployment design by further using point group data obtained from a new travel section as appropriate.

In FIG. 16, the travel trajectory in the first travel section is a travel trajectory 50a. First, the station deployment support apparatus 1 performs station deployment design based on point group data obtained with the mobile object, such as a vehicle, having an MMS mounted thereon by traveling the first travel section. At this time, if the value of the calculated confidence coefficient is not greater than a predetermined value, for example, the mobile object, such as a vehicle, having an MMS mounted thereon travels the second travel section. In FIG. 16, the travel trajectory in the second travel section is a travel trajectory 50b. The station deployment support apparatus 1 performs station deployment design by further using point group data obtained with the mobile object, such as a vehicle, having an MMS mounted thereon by traveling the second travel section. At this time, if the value of the calculated confidence coefficient is not greater than the predetermined value, for example, the mobile object, such as a vehicle, having an MMS mounted thereon travels the third travel section. In FIG. 16, the travel trajectory in the third travel section is a travel trajectory 50c. Then, the station deployment support apparatus 1 performs station deployment design by further using point group data obtained with the mobile object, such as a vehicle, having an MMS mounted thereon by traveling the third travel section.

In this manner, when the station deployment support apparatus 1 uses point group data obtained with the mobile object, such as a vehicle, having an MMS mounted thereon by traveling a new travel section as appropriate, the amount of calculation can be reduced. It is also possible to increase the possibility for a user to obtain a candidate position for installing a base station and a candidate position for installing a terminal station that satisfy a desired confidence coefficient in the station deployment design.

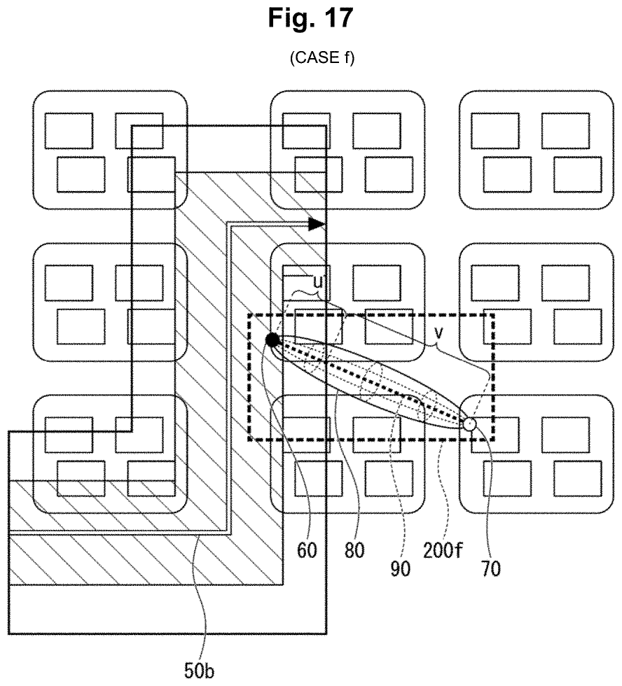

For example, FIG. 17 is an enlarged view of a part of a range around the travel trajectory 50b illustrated in FIG. 16. In the “case f” of the positional relationship configuration 200f illustrated in FIG. 17, a high proportion of the connecting line segment 90 is located outside the measurable range 110 when the mobile object, such as a vehicle, having an MMS mounted thereon travels along only the travel trajectory 50b. Therefore, according to Expression (1) described above, the confidence coefficient has a small value.

Specifically, according to Expression (1), the value of the confidence coefficient X is u/(u+v)×100[%].

In the present embodiment, the value of a confidence coefficient to serve as a predetermined threshold (hereinafter referred to as a “reference confidence coefficient value”) is set by the user in advance, for example. For example, a value, such as 70[%], is set in advance as the reference confidence coefficient value. When the calculated confidence coefficient is less than the reference confidence coefficient value, the station deployment support apparatus 1 performs station deployment design by further using point group data obtained with the mobile object, such as a vehicle, having an MMS mounted thereon by further traveling a new travel section.

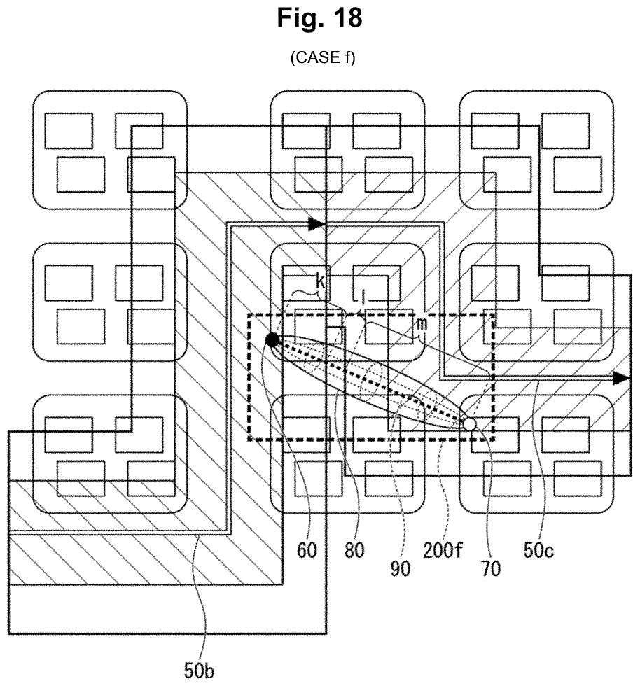

For example, FIG. 18 is an enlarged view of a part of the range around the travel trajectory 50b and a range around the travel trajectory 50c illustrated in FIG. 16. In the “case f” of the positional relationship configuration 200f illustrated in FIG. 17, the station deployment support apparatus 1 can perform station deployment design based on, in addition to the travel indicated by the travel trajectory 50b of the mobile object, such as a vehicle, having an MMS mounted thereon, the travel indicated by the travel trajectory 50c.

In the “case f” of the positional relationship configuration 200f illustrated in FIG. 18, the candidate base station position 60 is located within the travel section indicated by the travel trajectory 50b. Meanwhile, the candidate terminal station position 70 is located within the travel section indicated by the travel trajectory 50c. Therefore, in the “case f” of the positional relationship configuration 200f illustrated in FIG. 18, the station deployment support apparatus 1 can perform station deployment design using point group data in the measurable range 110 corresponding to the travel trajectory 50b and point group data in the measurable range 110 corresponding to the travel trajectory 50c.

As described above, when the candidate base station position 60 and the candidate terminal station position 70 are located within the measurable ranges 110 in the different travel sections, the confidence coefficient Y[%] that is the proportion of the connecting line segment 90 on the two-dimensional plane for which the vertical coordinate components are ignored, which is present within one of the measurable ranges 110, can be represented by the following Expression (2).

Y=Y₁+Y₂[%]

Y₁=k/(k+l+m)×100[%]

Y₂=m/(k+l+m)×100[%]

∴Y=(k+m)/(k+l+m)×100[%] (2)

When the confidence coefficient Y in the “case f” of the positional relationship configuration 200f illustrated in FIG. 18 and the confidence coefficient X in the “case f” of the positional relationship configuration 200f illustrated in FIG. 17 described above are compared, Y>X since k=u and l<v. Accordingly, the confidence coefficient Y corresponding to the case where point group data, which is obtained with the mobile object, such as a vehicle, having an MMS mounted thereon by further traveling a new travel section, is further used has a value with higher reliability. In this manner, further using point group data, which is obtained with the mobile object, such as a vehicle, having an MMS mounted thereon by further traveling a new travel section, as appropriate can increase the possibility of obtaining a confidence coefficient that satisfies the reference confidence coefficient value in the station deployment design.

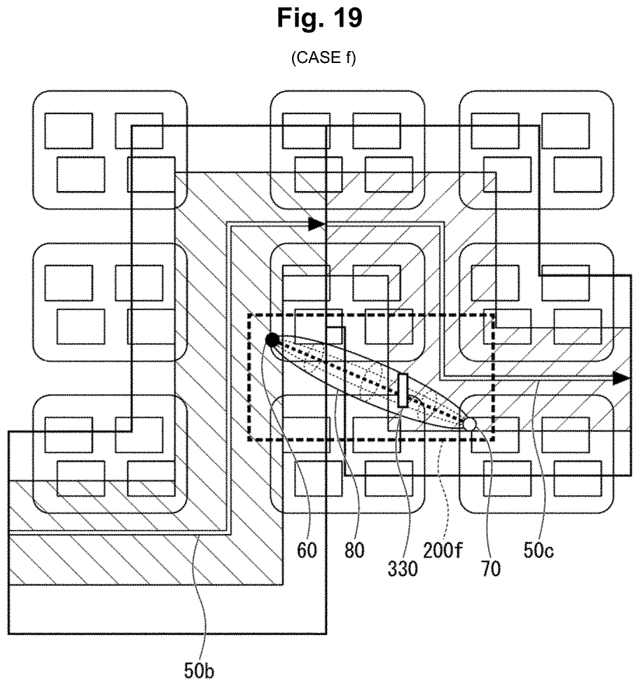

FIG. 19 illustrates the travel trajectory 50c along which a vehicle or the like having an MMS mounted thereon moves. When the vehicle travels a new travel section indicated by the travel trajectory 50c, it becomes possible to detect an object (i.e., an obstacle), such as a signboard 330, for example, present within the measurable range 110 corresponding to the travel trajectory 50c. Accordingly, the possibility that a space between the candidate base station position 60 and the candidate terminal station position 70 may be correctly determined to be “not visible” and have a “high shield factor” is increased.

Meanwhile, when the vehicle or the like having an MMS mounted thereon only travels the travel section indicated by the travel trajectory 50b, the signboard 330 illustrated in FIG. 19 is not detected. Therefore, in such a case, even though the signboard 330, which hinders visibility and increases the shield factor is actually present between the candidate base station position 60 and the candidate terminal station position 70, there is a high possibility that the space between the candidate base station position 60 and the candidate terminal station position 70 may be erroneously determined to be “visible” and have a “low shield factor.”

In the station deployment support apparatus 1 of the third embodiment, when the confidence coefficient identified by the confidence coefficient identification unit 22 does not satisfy the predetermined reference confidence coefficient value, the measurable range identification unit 30 generates measurable range data indicating a measurable range 110 in another travel section based on another piece of travel trajectory data and the measurable distance. Then, the confidence coefficient identification unit 22 performs, based on the proportion of the connecting line segment 90 present within one of the measurable ranges 110 and the other measurable range 110, identification of the confidence coefficient Y indicating the degree of reliability of the processing result of a predetermined evaluation process performed based on point group data.

Accordingly, since the station deployment support apparatus 1 of the third embodiment further uses point group data obtained with a mobile object, such as a vehicle, having an MMS mounted thereon by traveling a new travel section as appropriate, it is possible to increase the possibility of obtaining a confidence coefficient that satisfies the reference confidence coefficient value in the station deployment design. Accordingly, the station deployment support apparatus 1 of the third embodiment can improve the accuracy of a predetermined evaluation process, such as visibility determination or shield factor calculation for the space between the candidate base station position 60 and the candidate terminal station position 70.

It should be noted that as described above, the connecting line segment 90 present within the measurable range 110 further includes a line segment located within the neighboring range 100 and a line segment located outside the neighboring range 100. The neighboring range 100 is a range closer to the travel trajectory 50 of a mobile object, such as a vehicle, having an MMS mounted thereon. Therefore, the inside of the neighboring range 100 is a range in which point group data can be collected with higher density than in the outside of the neighboring range 100, and thus the reliability is higher. Thus, for example, “k” and “m” that represent the lengths of the connecting line segment 90 on the two-dimensional plane for which the vertical coordinate components are ignored, which are present within the respective measurable ranges 110, may be further divided into lengths “k₁” and “m₁” present within the respective neighboring ranges 100 and lengths “k₂” and “m₂” present outside the respective neighboring ranges 100, and weighting may be applied such that the value of k₁ becomes larger than that of k₂ and the value of m₁ becomes larger than that of m₂. Accordingly, the accuracy of the value of the confidence coefficient Y can be further increased.

(Modified example of third embodiment)

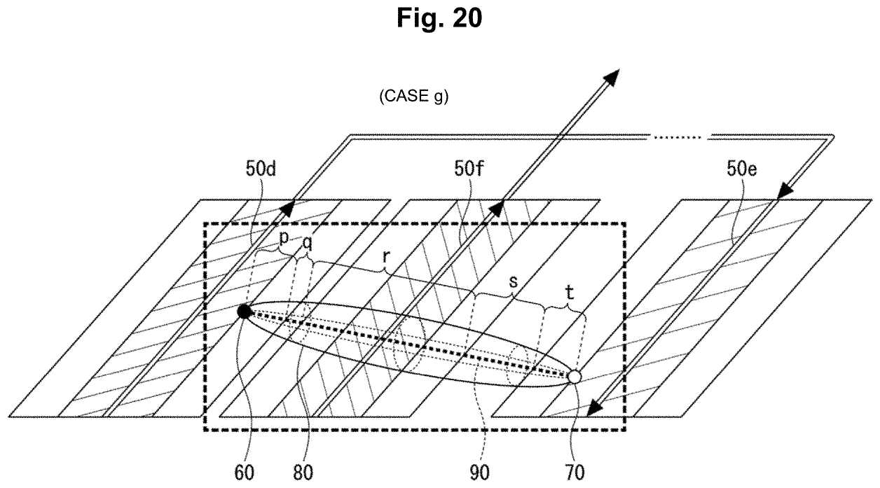

Further, a “case g” of a positional relationship configuration 200g illustrated in FIG. 20 is also considered. In the “case g” of the positional relationship configuration 200g illustrated in FIG. 20, the candidate base station position 60 is located within a travel section indicated by a travel trajectory 50d. Meanwhile, the candidate terminal station position 70 is located within a travel section indicated by a travel trajectory 50e. Further, there is another travel section indicated by a travel trajectory 50f between the travel section indicated by the travel trajectory 50d and the travel section indicated by the travel trajectory 50e. Therefore, in the “case g” of the positional relationship configuration 200g illustrated in FIG. 20, the station deployment support apparatus 1 can perform station deployment design using point group data in the measurable range 110 corresponding to the travel trajectory 50d, point group data in the measurable range 110 corresponding to the travel trajectory 50e, and point group data in the measurable range 110 corresponding to the travel trajectory 50f.

In this manner, when the candidate base station position 60 and the candidate terminal station position 70 are located within different travel sections and there is further another travel section between the two travel sections, the confidence coefficient Z[%] that is the proportion of the connecting line segment 90 on the two-dimensional plane for which the vertical coordinate components are ignored, which is present within the measurable range 110, can be represented by the following Expression (3).

Z=Z₁+Z₂+Z₃[%]

Z₁=p/(p+q+r+s+t)×100[%]

Z₂=r/(p+q+r+s+t)×100[%]

Z₃=t/(p+q+r+s+t)×100[%]

∴Z=(p+r+t)/(p+q+r+s+t)×100[%] (3)

When a vehicle or the like having an MMS mounted thereon has travelled only the travel section indicated by the travel trajectory 50d, the confidence coefficient is Z₁. When the vehicle or the like having an MMS mounted thereon has further travelled the travel section indicated by the travel trajectory 50e, the confidence coefficient is Z₁+Z₃. When the vehicle or the like having an MMS mounted thereon has further travelled the travel section indicated by the travel trajectory 50f, the confidence coefficient is Z₁+Z₂+Z₃.

In the station deployment support apparatus 1 of a modified example of the third embodiment, the confidence coefficient identification unit 22 performs, when there is a third measurable range 110 between a first measurable range 110 including the candidate base station position 60 and a second measurable range 110 including the candidate terminal station position 70, identification of the confidence coefficient Z indicating the degree of reliability of the processing result of a predetermined evaluation process performed based on point group data, based on the proportion of the connecting line segment 90 present within each of the first measurable range 110, the second measurable range 110, and the third the measurable range 110.

Accordingly, since the station deployment support apparatus 1 of the modified example of the third embodiment further uses point group data obtained with a mobile object, such as a vehicle, having an MMS mounted thereon by traveling a new travel section as appropriate, it is possible to further increase the possibility of obtaining a confidence coefficient that satisfies the reference confidence coefficient value in the station deployment design. Accordingly, since the station deployment support apparatus 1 of the modified example of the third embodiment can detect obstacles present within the third measurable range 110, it is possible to improve the accuracy of a predetermined evaluation process, such as visibility determination or shield factor calculation, for the space between the candidate base station position 60 and the candidate terminal station position 70.

It should be noted that in the “case g” of the positional relationship configuration 200g illustrated in FIG. 20, there is only one more travel section between the travel section in which the candidate base station position 60 is present and the travel section in which the candidate terminal station position 70 is present. However, there may be two or more travel sections. In such a case, it is possible to perform station deployment design using all pieces of point group data in the measurable ranges 110 corresponding to the travel trajectories of a mobile object, such as a vehicle, having an MMS mounted thereon in the two or more travel sections. Accordingly, it is possible to further increase the possibility of obtaining a confidence coefficient that satisfies the reference confidence coefficient value in the station deployment design.

It should be noted that as described above, the connecting line segment 90 present within the measurable range 110 further includes a line segment located within the neighboring range 100 and a line segment located outside the neighboring range 100. The neighboring range 100 is a range closer to the travel trajectory 50 of a mobile object, such as a vehicle, having an MMS mounted thereon. Therefore, the inside of the neighboring range 100 is a range in which point group data can be collected with higher density than in the outside of the neighboring range 100, and thus the reliability is higher. Thus, for example, “p,” “r,” and “t” that represent the lengths of the connecting line segment 90 on the two-dimensional plane for which the vertical coordinate components are ignored, which are present within the respective measurable ranges 110, may be further divided into lengths “p₁,” “r₁,” and “t₁” present within the respective neighboring ranges 100 and lengths “p₂,” “r₂,” and “t₂” present outside the respective neighboring ranges 100, and weighting may be applied such that the value of p₁ becomes larger than that of p₂, the value of r₁ becomes larger than that of r₂, and the value of t₁ becomes larger than that of t₂. Accordingly, the accuracy of the value of the confidence coefficient Z can be further increased.

### Process of Third Embodiment

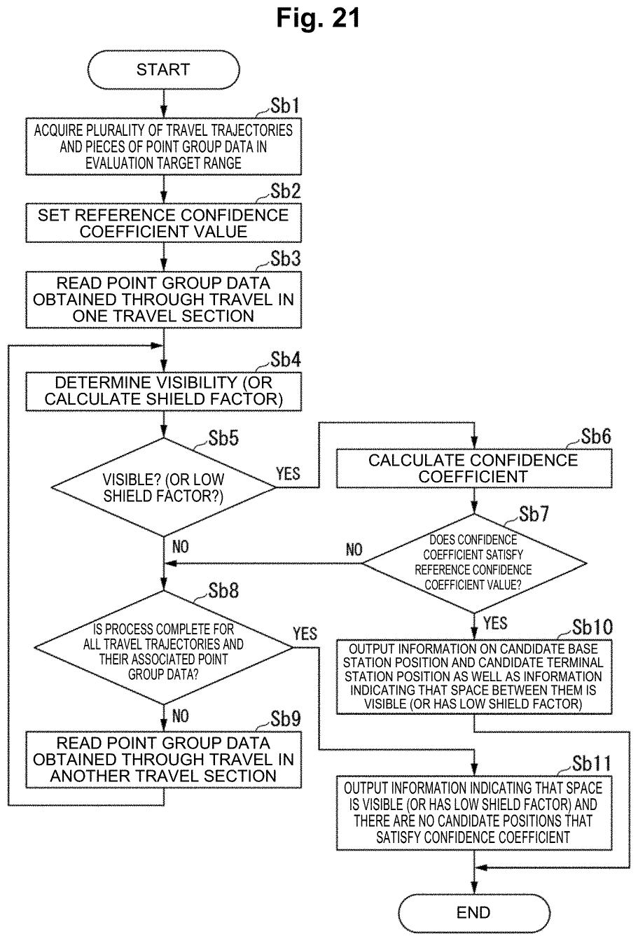

FIG. 21 is a flowchart illustrating a station deployment support method according to the third embodiment. First, the station deployment support apparatus 1 acquires a plurality of travel trajectories of a mobile object, such as a vehicle, having an MMS mounted thereon as well as pieces of point group data obtained through travel indicated by the travel trajectories, in an evaluation target range (step Sb1).

Next, the station deployment support apparatus 1 sets a reference confidence coefficient value in advance based on the user's operation of inputting a desired reference confidence coefficient value, for example (step Sb2). Next, the station deployment support apparatus 1 reads point group data obtained through travel of the mobile object, such as a vehicle, having an MMS mounted thereon in one travel section (step Sb3).

Next, the station deployment support apparatus 1 determines visibility (or calculates the shield factor) for each combination of the candidate base station position 60 and the candidate terminal station position 70 (step Sb4). Next, if the station deployment support apparatus 1 determines that the space between the candidate base station position 60 and the candidate terminal station position 70 is visible (or determines that the shield factor of the space between the candidate base station position 60 and the candidate terminal station position 70 is low) (step Sb5, Yes), the station deployment support apparatus 1 calculates the confidence coefficient for each combination of the candidate base station position 60 and the candidate terminal station position 70 (step Sb6).

Meanwhile, if the station deployment support apparatus 1 determines that the space between the candidate base station position 60 and the candidate terminal station position 70 is not visible (or determines that the shield factor of the space between the candidate base station position 60 and the candidate terminal station position 70 is high) (step Sb5, No), the process proceeds to step Sb8 described below.

The station deployment support apparatus 1 determines if the confidence coefficient calculated in step Sb6 satisfies the reference confidence coefficient value set in step Sb2 (step Sb7). If the station deployment support apparatus 1 determines that the confidence coefficient satisfies the reference confidence coefficient value (step Sb7, Yes), the station deployment support apparatus 1 outputs information on the candidate base station position 60 and the candidate terminal station position 70 as well as information indicating the determination result that the space between the candidate base station position 60 and the candidate terminal station position 70 is visible (or the shield factor of the space between the candidate base station position 60 and the candidate terminal station position 70) (step Sb10). It should be noted that the station deployment support apparatus 1 may further output the value of the confidence coefficient. Accordingly, the flowchart illustrating the station deployment support method illustrated in FIG. 21 ends.

Meanwhile, if the station deployment support apparatus 1 determines that the confidence coefficient does not satisfy the reference confidence coefficient value (step Sb7, No), the process proceeds to step Sb8 described below. In step Sb8, the station deployment support apparatus 1 determines if the process of visibility determination (or shield factor calculation) is complete for each combination of the candidate base station position 60 and the candidate terminal station position 70 regarding all travel trajectories and their associated point group data.

If the station deployment support apparatus 1 determines that the process of visibility determination (or shield factor calculation) is not complete for each combination of the candidate base station position 60 and the candidate terminal station position 70 regarding at least one travel trajectory and its associated point group data (step Sb8, No) the station deployment support apparatus 1 reads point group data obtained through travel of the mobile object, such as a vehicle, having an MMS mounted thereon, in another travel section (step Sb9). Then, the station deployment support apparatus 1 returns to the process of step Sb4 described above to repeat a similar process.

Meanwhile, if the station deployment support apparatus 1 determines that the process of visibility determination (or shield factor calculation) is complete for each combination of the candidate base station position 60 and the candidate terminal station position 70 regarding all travel trajectories and their associated point group data (step Sb8, Yes), the station deployment support apparatus 1 outputs information indicating that the space between the candidate base station position 60 and the candidate terminal station position 70 is visible (or the shield factor of the space between the candidate base station position 60 and the candidate terminal station position 70 is low), and there is no combination of the candidate base station position 60 and the candidate terminal station position 70 that achieves a confidence coefficient that satisfies the reference confidence coefficient value (step Sb11). Accordingly, the flowchart illustrating the station deployment support method illustrated in FIG. 21 ends.

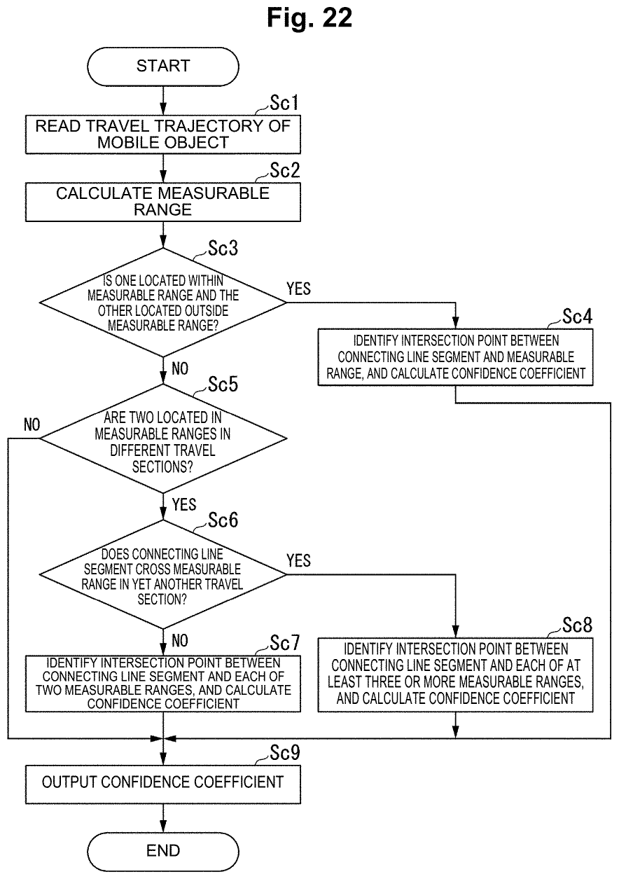

FIG. 22 is a flowchart illustrating a process of station deployment support performed by the point group data processing unit 6 in the station deployment support apparatus of the third embodiment. First, the point group data processing unit 6 reads the travel trajectory of a mobile object, such as a vehicle, having an MMS mounted thereon (step Sc1). Then, the point group data processing unit 6 calculates the measurable range 110 within the distance, which allows for the acquisition of point group data, from each position on the read travel trajectory in a direction at a right angle to the travelling direction of the mobile object (step Sc2).

Next, the point group data processing unit 6 determines if one of the candidate base station position 60 and the candidate terminal station position 70 is located within the measurable range 110 and the other is located outside the measurable range 110 (which corresponds to the aforementioned “case b,” for example) (step Sc3).

If the point group data processing unit 6 determines that the candidate base station position 60 and the candidate terminal station position 70 correspond to the case where one of them is located within the measurable range 110 and the other is located outside the measurable range 110 (step Sc3, Yes), the point group data processing unit 6 identifies the position of intersection point between the connecting line segment 90 between the candidate base station position 60 and the candidate terminal station position 70 and the measurable range 110. Then, the point group data processing unit 6 calculates the proportion of the connecting line segment 90 within the measurable range 110 and the proportion of the connecting line segment 90 outside the measurable range 110 based on the candidate base station position 60, the candidate terminal station position 70, and the position of intersection point, and calculates the confidence coefficient X based on Expression (1) described above (step Sc4). Then, the point group data processing unit 6 outputs the calculated confidence coefficient X (step Sc9). Accordingly, the operation of the point group data processing unit 6 illustrated in the flowchart of FIG. 22 ends.

Meanwhile, if the point group data processing unit 6 determines that the candidate base station position 60 and the candidate terminal station position 70 do not correspond to the case where one of them is located within the measurable range 110 and the other is located outside the measurable range 110 (step Sc3, No), the point group data processing unit 6 determines if the candidate base station position 60 and the candidate terminal station position 70 are located within measurable ranges 110 in different travel sections (which corresponds to the aforementioned “case f,” for example) (step Sc5).

If the point group data processing unit 6 determines that the candidate base station position 60 and the candidate terminal station position 70 do not correspond to the case where the two are located within measurable ranges 110 in different travel sections (step Sc5, No), the point group data processing unit 6 outputs a confidence coefficient (step Sc9). It should be noted that when the determination result of step Sc5 is “No” corresponds to a case where both the candidate base station position 60 and the candidate terminal station position 70 are located within a measurable range in an identical travel section (which corresponds to the aforementioned “case a,” for example) or a case where both the candidate base station position 60 and the candidate terminal station position 70 are located outside the measurable range (which corresponds to the aforementioned “case c,” for example). When the candidate base station position 60 and the candidate terminal station position 70 correspond to the case where both are located within a measurable range in an identical travel section, the point group data processing unit 6 outputs information indicating that the confidence coefficient is 100[%] (step Sc9). Meanwhile, when the candidate base station position 60 and the candidate terminal station position 70 correspond to the case where both are located outside the measurable range, the point group data processing unit 6 outputs information indicating that the confidence coefficient is 0[%] (step Sc9). Accordingly, the operation of the point group data processing unit 6 illustrated in the flowchart of FIG. 22 ends.

Meanwhile, if the point group data processing unit 6 determines that the candidate base station position 60 and the candidate terminal station position 70 correspond to the case where the two are located within measurable ranges in different travel sections (step Sc5, Yes), the point group data processing unit 6 determines if the connecting line segment 90 connecting the candidate base station position 60 and the candidate terminal station position 70 crosses a measurable range 110 in further another travel section that differs from the measurable range 110 in the travel section including the candidate base station position 60 or the candidate terminal station position 70 (which corresponds to the aforementioned “case g,” for example) (step Sc6).

If the point group data processing unit 6 determines that the connecting line segment 90 connecting the candidate base station position 60 and the candidate terminal station position 70 does not correspond to the case where it crosses a measurable range in further another travel section that differs from the measurable range 110 corresponding to the travel section in which the candidate base station position 60 or the candidate terminal station position 70 is located (step Sc6, No), the point group data processing unit 6 identifies the position of the intersection point between the connecting line segment 90 between the candidate base station position 60 and the candidate terminal station position 70 and each measurable range 110. Then, the point group data processing unit 6 calculates the proportion of the connecting line segment 90 within the measurable range 110 and the proportion of the connecting line segment 90 outside the measurable range 110 based on the candidate base station position 60, the candidate terminal station position 70, and the position of each intersection point, and calculates the confidence coefficient Y based on Expression (2) described above (step Sc7). Then, the point group data processing unit 6 outputs the calculated confidence coefficient Y (step Sc9). Accordingly, the operation of the point group data processing unit 6 illustrated in the flowchart of FIG. 22 ends.

Meanwhile, if the point group data processing unit 6 determines that the connecting line segment 90 connecting the candidate base station position 60 and the candidate terminal station position 70 corresponds to the case where it crosses a measurable range 110 in further another travel section that differs from the measurable range 110 corresponding to the travel section in which the candidate base station position 60 or the candidate terminal station position 70 is located (step Sc6, Yes), the point group data processing unit 6 identifies the position of the intersection point between the connecting line segment 90 between the candidate base station position 60 and the candidate terminal station position 70 and each measurable range 110 including one of the candidate base station position 60 or the candidate terminal station position 70. Further, the point group data processing unit 6 identifies the position of the intersection point between the connecting line segment 90 and at least one measurable range 110 including neither the candidate base station position 60 nor the candidate terminal station position 70. That is, the point group data processing unit 6 identifies the positions of the intersection points between the connecting line segment 90 and at least three measurable ranges 110.

Then, the point group data processing unit 6 calculates the proportion of the connecting line segment 90 within the measurable range 110 and the proportion of the connecting line segment 90 outside the measurable range 110 based on the candidate base station position 60, the candidate terminal station position 70, and the position of each intersection point, and calculates the confidence coefficient Z based on Expression (3) described above (step Sc8). Then, the point group data processing unit 6 outputs the calculated confidence coefficient Z (step Sc9). Accordingly, the operation of the point group data processing unit 6 illustrated in the flowchart of FIG. 22 ends.

### Fourth Embodiment

There is a case where a plurality of candidate terminal station positions 70 are present with respect to one candidate base station position 60. In the present embodiment, when a plurality of candidate terminal station positions 70 are present, the confidence coefficient identification unit 22 identifies the confidence coefficient for each of the candidate terminal station positions 70. Then, the station deployment support apparatus 1 presents to the user the candidate terminal station position 70 for which the confidence coefficient has a higher value. Hereinafter, a case where two candidate terminal station positions 70 are present with respect to the candidate base station position 60 will be considered as an example.

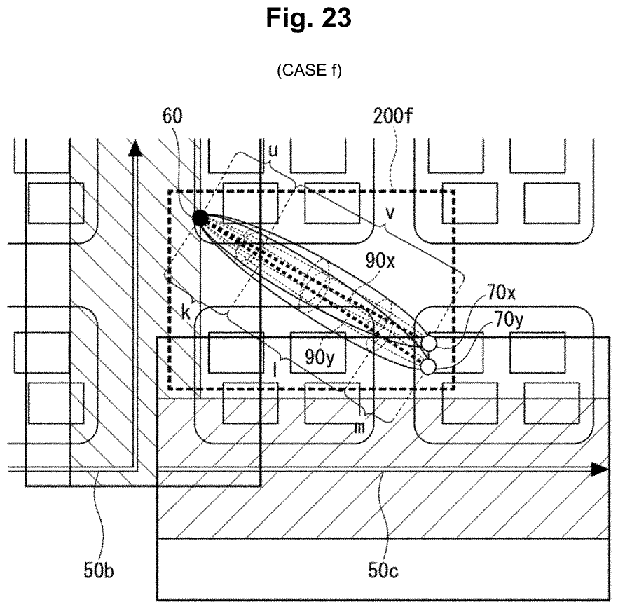

FIG. 23 is a view illustrating an example in which a plurality of candidate terminal station positions 70 are present. As illustrated in FIG. 23, herein, the aforementioned “case f” represented by the positional relationship configuration 200f is considered. A candidate terminal station position 70x and a candidate terminal station position 70y are present with respect to the candidate base station position 60. A line segment connecting the candidate base station position 60 and the candidate terminal station position 70x is referred to as a connecting line segment 90x. In addition, a line segment connecting the candidate base station position 60 and the candidate terminal station position 70y is referred to as a connecting line segment 90y.

Regarding the candidate terminal station position 70x, the confidence coefficient X is u/(u+v)×100[%] as indicated by Expression (1) described above. Meanwhile, regarding the candidate terminal station position 70x, the confidence coefficient Y is (k+m)/(k+l+m)×100[%] as indicated by Expression (2) described above. Herein, as illustrated in FIG. 23, since v/(u+v)>l/(k+l+m), X<Y. Therefore, the station deployment support apparatus 1 of the present embodiment presents to the user the candidate terminal station position 70y for which the confidence coefficient has a higher value.

In the station deployment support apparatus 1 of the fourth embodiment, when a plurality of candidate terminal station positions 70 are selected, the candidate three-dimensional position selection unit 20 identifies a candidate terminal station position 70 from among the plurality of candidate terminal station positions 70 based on each of the confidence coefficients identified by the confidence coefficient identification unit 22.

Accordingly, the station deployment support apparatus 1 of the fourth embodiment can increase the possibility of obtaining a confidence coefficient that satisfies the reference confidence coefficient value in the station deployment design.

Although the aforementioned first to fourth embodiments have exemplarily illustrated millimeter-wave wireless communication as the wireless communication performed between a base station apparatus installed at the candidate base station position 60 and a terminal station apparatus installed at the candidate terminal station position 70, communication other than the millimeter-wave wireless communication may also be performed, such as terrestrial digital communication, satellite radio communication, or communication for which UHF (Ultra High Frequency) is used.

In the aforementioned first to fourth embodiments, the determination processes are performed using an inequality sign or an inequality sign with an equality sign. However, the present invention is not limited to such embodiments, and the determination processes including determination conditions such as “if/whether . . . is greater than,” “if/whether . . . is less than,” “if/whether . . . is greater than or equal to,” and “if/whether . . . is less than or equal to” are only exemplary. Thus, depending on the way in which thresholds are determined, such determination processes may be replaced with determination processes including determination conditions such as “if/whether . . . is greater than or equal to,” “if/whether . . . is less than or equal to,” “if/whether . . . is greater than,” and “if/whether . . . is less than,” respectively. In addition, the thresholds used for such determination processes are also only exemplary. Thus, different thresholds may be applied to the respective determination processes.

The station deployment support apparatus 1 in each of the aforementioned embodiments may be implemented by a computer. In such a case, it is possible to implement the apparatus by recording a program for implementing the function of the apparatus on a computer readable recording medium and causing a computer system to read the program recorded on the recording medium and thus execute the program. It should be noted that the “computer system” herein includes hardware, such as an OS and peripheral devices. In addition, the “computer readable recording medium” refers to a portable medium, such as a flexible disk, a magneto-optical disk, ROM, or CD-ROM; or a storage device, such as a hard disk, incorporated in the computer system. Further, the “computer readable recording medium” may include a medium that dynamically holds a program for a short period of time, such as a communication line used for transmitting a program via a network like the Internet or a communication line like a telephone line; and a medium that holds a program for a given period of time, such as a volatile memory in a computer system that serves as a server or a client in the aforementioned case. In addition, the aforementioned program may be a program for implementing a part of the aforementioned function, or a program that can implement the aforementioned function by being combined with a program already recorded on the computer system. Alternatively, the aforementioned program may be a program implemented using a programmable logic device, such as an FPGA (Field Programmable Gate Array).

Although the embodiments of the invention have been described in detail with reference to the drawings, specific configurations are not limited thereto and thus include design that is within the spirit and scope of the invention.

### INDUSTRIAL APPLICABILITY

When performing station deployment design for determining the places for installing a wireless base station and a wireless terminal station by utilizing point group data, it is possible to apply the point group data to the determination of visibility or the calculation of the shield factor for a space between a base station to be installed in an outdoor facility, such as a utility pole, and a terminal station to be installed on a wall surface of a building.

### REFERENCE SIGNS LIST

1 (1a) Station deployment support apparatus
2 Design area designation unit
3 Candidate base station position extraction unit
4 Candidate terminal station position extraction unit
5 Determination processing unit
6 (6a) Point group data processing unit
7 Number-of-stations calculation unit
10 Operation processing unit
11 Map data storage unit
12 Facility data storage unit
13 Point group data storage unit
14 Travel trajectory data storage unit
15 Determination result storage unit
21 (21a) Positional relationship identification unit
22 (22a) Confidence coefficient identification unit
23 Determination processing unit
24 Shield factor calculation unit
25 Storage unit
26 Connecting line segment identification unit
28 Measurable range proportion calculation unit
30 Measurable range identification unit
31 Measurable range presence determination unit
32 Neighboring range identification unit
33 Neighboring range presence determination unit
34 Determination result storage unit
50 (50a to 50f) Travel trajectory
60 (60b, 60d) Candidate base station position
70 (70b, 70d, 70x, 70y) Candidate terminal station position
80 (80b, 80d) Fresnel zone
90 (90x, 90y) Connecting line segment
100 Neighboring range
110 Measurable range
200 (200a to 200g) Positional relationship configuration
300 (300a, 300b, 300m, 300n) Site
310a (310a-1, 310b-1) Building
320 (320a-1 to 320a-3) Tree
330 (330b) Signboard
400 Road
800, 801 Building
810 to 812 House
821 to 826 Utility pole
830 to 834 Base station
840 to 844 Terminal station
900 to 901 Optical fiber

1. A station deployment support method comprising:
a positional relationship identification step of, based on travel trajectory data indicating a travel trajectory of a mobile object that measures an object present in a three-dimensional space within a predetermined measurable distance and acquires point group data indicating a position of the measured object in the three-dimensional space, the measurable distance, candidate base station position data indicating a candidate position for installing a base station apparatus, and candidate terminal station position data indicating a candidate position for installing a terminal station apparatus, generating base station positional relationship identification data indicating a positional relationship between the travel trajectory and a candidate base station position, and terminal station positional relationship identification data indicating a positional relationship between the travel trajectory and a candidate terminal station position;
a first measurable range identification step of, based on first travel trajectory data and the measurable distance, generating measurable range data indicating a first measurable range;
a connecting line segment identification step of, based on the candidate base station position data and the candidate terminal station position data, generating connecting line segment data indicating a connecting line segment connecting the candidate base station position and the candidate terminal station position; and
a first confidence coefficient identification step of, based on a proportion of the connecting line segment present within the first measurable range, identifying a confidence coefficient indicating a degree of reliability of a processing result of a predetermined evaluation process performed based on the point group data.

2. The station deployment support method according to claim 1, further comprising, when the confidence coefficient identified in the first confidence coefficient identification step does not satisfy a predetermined reference value:
a second measurable range identification step of, based on second travel trajectory data and the measurable distance, generating measurable range data indicating a second measurable range; and
a second confidence coefficient identification step of, based on a proportion of the connecting line segment present within the first measurable range and the second measurable range, identifying a confidence coefficient indicating a degree of reliability of a processing result of a predetermined evaluation process performed based on the point group data.

3. The station deployment support method according to claim 2, further comprising, when a third measurable range is present between the first measurable range and the second measurable range:
a third confidence coefficient identification step of, based on a proportion of the connecting line segment present within the first measurable range, the second measurable range, and the third measurable range, identifying a confidence coefficient indicating a degree of reliability of a processing result of a predetermined evaluation process performed based on the point group data.

4. The station deployment support method according to claim 2, further comprising, when a plurality of candidate terminal station positions are selected:
a three-dimensional candidate position selection step of, based on the confidence coefficient identified in the first confidence coefficient identification step or the second confidence coefficient identification step, identifying the candidate terminal station position from among the plurality of candidate terminal station positions.

5. A station deployment support apparatus comprising:
a positional relationship identification unit that, based on travel trajectory data indicating a travel trajectory of a mobile object that measures an object present in a three-dimensional space within a predetermined measurable distance and acquires point group data indicating a position of the measured object in the three-dimensional space, the measurable distance, candidate base station position data indicating a candidate position for installing a base station apparatus, and candidate terminal station position data indicating a candidate position for installing a terminal station apparatus, generates base station positional relationship identification data indicating a positional relationship between the travel trajectory and a candidate base station position, and terminal station positional relationship identification data indicating a positional relationship between the travel trajectory and a candidate terminal station position;
a measurable range identification unit that generates measurable range data indicating a measurable range based on the travel trajectory data and the measurable distance;
a connecting line segment identification unit that, based on the candidate base station position data and the candidate terminal station position data, generates connecting line segment data indicating a connecting line segment connecting the candidate base station position and the candidate terminal station position; and
a confidence coefficient identification unit that, based on a proportion of the connecting line segment present within the measurable range, identifies a confidence coefficient indicating a degree of reliability of a processing result of a predetermined evaluation process performed based on the point group data.

6. A station deployment support program for causing a computer to execute:
a positional relationship identification step of, based on travel trajectory data indicating a travel trajectory of a mobile object that measures an object present in a three-dimensional space within a predetermined measurable distance and acquires point group data indicating a position of the measured object in the three-dimensional space, the measurable distance, candidate base station position data indicating a candidate position for installing a base station apparatus, and candidate terminal station position data indicating a candidate position for installing a terminal station apparatus, generating base station positional relationship identification data indicating a positional relationship between the travel trajectory and a candidate base station position, and terminal station positional relationship identification data indicating a positional relationship between the travel trajectory and a candidate terminal station position;
a measurable range identification step of generating measurable range data indicating a measurable range based on the travel trajectory data and the measurable distance;
a connecting line segment identification step of, based on the candidate base station position data and the candidate terminal station position data, generating connecting line segment data indicating a connecting line segment connecting the candidate base station position and the candidate terminal station position; and
a confidence coefficient identification step of, based on a proportion of the connecting line segment present within the measurable range, identifying a confidence coefficient indicating a degree of reliability of a processing result of a predetermined evaluation process performed based on the point group data.
